(19) United States
(12) Patent Application Publication
(10) Pub. No.: US 2022/0223993 A1
(43) Pub. Date: Jul. 14, 2022

(54) CELLULAR BASE STATION ASSEMBLIES

(71) Applicant: CommScope Technologies LLC, Hickory, NC (US)

(72) Inventors: Ulrich Albert Gienger, Fairview, TX (US); Jignesh Patel, Plano, TX (US); Richard D. Williams, Wylie, TX (US); Tri Nguyen, Richardson, TX (US); Jeffrey C. Cook, Allen, TX (US); Charles J. Mann, Omaha, NE (US); Sam Firouzbakht, Royal Oak, MI (US); Mike Rito, Sunnyvale, CA (US)

(21) Appl. No.: 17/567,391

(22) Filed: Jan. 3, 2022

Related U.S. Application Data
(60) Provisional application No. 63/134,995, filed on Jan. 8, 2021.
(60) Provisional application No. 63/149,462, filed on Feb. 15, 2021.

(51) Int. Cl. H01Q 1/06; H01Q 1/44; H01Q 1/12; F21V 23/02; H01Q 1/24; F21S 8/08

(52) U.S. Cl. CPC H01Q 1/06; H01Q 1/44; F21S 8/085; F21V 23/02; H01Q 1/246; H01Q 1/1242

(57) ABSTRACT

A module for a metrocell assembly includes: a hollow, elongate cylindrical housing; and at least one power rail extending longitudinally on the exterior of the housing. The at least one power rail is configured to receive an accessory mounted on the power rail and to provide electrical contact from within the housing to the accessory.

### RELATED APPLICATION

The present application claims priority from and the benefit of U.S. Provisional Patent Application Nos. 63/134,995, filed Jan. 8, 2021, and 63/149,462, filed Feb. 15, 2021, the disclosure of which are hereby incorporated by reference herein in full.

### FIELD OF THE INVENTION

The present invention is directed generally toward communication antennas, and more particularly to mounting structures for communications antennas.

### BACKGROUND

As wireless data service demands have grown, a conventional response has been to increase the number and capacity of conventional cellular Base Stations (Macro-Cells). The antennas used by such Macro-Cells are typically mounted on antenna towers. A conventional antenna tower has three or four legs on which antennas and supporting remote radio units (RRUs) are mounted. However, in some environments structures known as “monopoles” are used as mounting structures. Monopoles are typically employed when fewer antennas/RRUs are to be mounted, and/or when a structure of less height is required.

In addition, Macro-Cell sites are becoming less available, and available spectrum limits how much additional capacity can be derived from a given Macro-Cell. Accordingly, small cell RRU and antenna combinations have been developed to “fill in” underserved or congested areas that would otherwise be within a Macro-Cell site. Deployment of small cells, particularly in urban environments, is expected to continue to grow. Often such small cell configurations (sometimes termed “Metrocells”) are mounted on monopoles. Typically, these small cell configurations do not permit mounting of other equipment above the antenna.

In some instances, metrocells may be mounted on existing structures, such as buildings, billboards, kiosks, and the like. See, e.g., U.S. Patent Publication No. 2017/0324154 to Hendrix e al, and U.S. Patent Publication No. 2020/0411945, each of which is hereby incorporated herein by reference in full. In addition, metrocells may be mounted on streetlight poles and the like. See, e.g., U.S. Patent Publication No. 2021/0328337, the disclosure of which is hereby incorporated herein in full by references. In view of the foregoing, it may be desirable to provide additional metrocell arrangements.

### SUMMARY

As a first aspect, embodiments of the invention are directed to a module for a metrocell assembly comprising: a hollow, elongate cylindrical housing; and at least one power rail attached to and extending longitudinally relative to the housing and accessible from the exterior of the housing. The at least one power rail is configured to receive an accessory mounted on the power rail and to provide electrical contact from within the housing to the accessory.

As a second aspect, embodiments of the invention are directed to a module for a metrocell assembly comprising: a hollow, elongate cylindrical housing; two power rails extending longitudinally on the exterior of the housing; and a first accessory mounted on a first one of the power rails, the first accessory in electrical contact with the power rail and receiving electrical power from within the housing through the first power rail.

As a third aspect, embodiments of the invention are directed to a module for a metrocell assembly comprising: a hollow elongate cylindrical housing having a recessed section; and an accessory, the accessory mounted to the recessed section via a clamp arrangement.

As a fourth aspect, embodiments of the invention are directed to a module for a metrocell assembly comprising: a plurality of outer sections, each of the outer sections extending longitudinally, the outer sections arranged to form generally a cylinder; wherein the outer sections include features that form at least one channel configured for the mounting of an accessory therein.

As a fifth aspect, embodiments of the invention are directed to a module for a metrocell comprising: a central frame comprising a cylindrical base and a plurality of spokes extending radially outwardly from the cylindrical base; a plurality of compartment covers extending between adjacent spokes to form a plurality of compartments; and a plurality of track covers extending between adjacent spokes to form a plurality of tracks.

As a sixth aspect, embodiments of the invention are directed to z module for a metrocell comprising: a generally cylindrical housing, wherein a hand hole is formed on one side of the housing, and a mounting location for an accessory is formed diametrically opposite of the hand hole.

As a seventh aspect, embodiments of the invention are directed to an assembly of stacked modules for a metrocell comprising: a first module having first joining features; and a second module having second joining features that interact with the first joining features to secure the first and second modules together.

### BRIEF DESCRIPTION OF THE FIGURES

FIGS. 1A and 1B are front and side views of prior art metrocell assemblies based on a modular concept.

FIG. 2 is a front view of a metrocell assembly according to embodiments of the invention.

FIG. 3 is an exploded front view of the metrocell assembly of FIG. 2.

FIG. 4 is a front view of six different exemplary metrocell assemblies according to embodiments of the invention.

FIGS. 5A-5C are perspective views of metrocell assemblies according to embodiments of the invention in which different luminaire configurations are mounted.

FIG. 6 is a perspective view of a metrocell assembly that employs a flat frame-style luminaire.

FIG. 7 is an exploded perspective view of a top portion of a metrocell assembly in which a cone-style luminaire is employed.

FIGS. 8A and 8B are exploded and assembled views of a metrocell assembly in which a stackable attachment technique for a huminaire is employed.

FIG. 9 is a perspective view of the top portion of the metrocell assembly of FIG. 2.

FIGS. 10 and 11 are intact and exploded perspective views of a camera attachment configuration according to embodiments of the invention.

FIGS. 12 and 13 are partial perspective views of the metrocell assembly of FIG. 2 illustrating a street sign and a banner mounted in the power rail.

FIG. 14 is a partial perspective view of two street signs mounted in the power rail of a metrocell assembly.

FIG. 15 is a front view of a metrocell assembly in which a base and a power module are employed in a stacked configuration.

FIG. 16 is a partial perspective view of banners mounted on a metrocell assembly via a rail.

FIG. 17 is a partial perspective view of banners mounted on a metrocell assembly via a bolt-on attachment.

FIG. 18 is a partial perspective view of a crosswalk light mounted to a metrocell pole via a clamp attachment.

FIG. 19 is a partial perspective view of a crosswalk light welded to a metrocell pole.

FIG. 20 is an exploded view of a metrocell assembly in which access doors are located near the bottom of each stackable module.

FIG. 21 is a partial perspective view of a metrocell assembly according to embodiments of the invention showing access doors.

FIG. 22 is a schematic side view of the metrocell assembly of FIG. 21 showing the air flow pattern around the access door.

FIGS. 23 and 24 are perspective views showing the attachment of a bench to a metrocell pole.

FIG. 25 is a partial perspective view of a round bench mounted to a metrocell pole.

FIG. 26 is a perspective view of a bench mounted to a metrocell pole.

FIG. 27 is a cross-section view of a metrocell pole according to alternative embodiments of the invention.

FIGS. 28A and 28B are perspective and section views illustrating one embodiment of the pole of FIG. 27.

FIGS. 29A and 29B are perspective and section views illustrating another embodiment of the pole of FIG. 27.

FIG. 30 is a section view of a lower module of a metrocell assembly according to embodiments of the invention.

FIG. 31 is a section view of an upper module of the metrocell assembly of FIG. 30.

FIG. 32 is a perspective view of a luminaire mounting module for a metrocell assembly according to embodiments of the invention, wherein the outer surface is shown as transparent for clarity.

FIG. 33 is a perspective view of the luminaire module of FIG. 32.

FIGS. 34A-C are perspective views showing a hand hole providing access for a technician to the interior of the luminaire module of FIG. 32.

FIGS. 35A and 35B are exploded and assembled views of the huminaire module of FIG. 32.

FIGS. 36A and 36B are exploded and assembled views of a huminaire module according to another embodiment of the invention.

FIGS. 37A and 37B are exploded and assembled view of a luminaire module according to further embodiments of the invention.

FIGS. 38A and 38B are exploded and assembled view of a metrocell assembly according to further embodiments of the invention.

FIGS. 39A and 39B are front assembled and exploded views of the metrocell assembly of FIG. 38A.

FIG. 40 is an exploded perspective view of the metrocell assembly of FIG. 38A illustrating an attachment method between modules.

FIGS. 41A-C are perspective views of the metrocell assembly of FIG. 38A shown with external covers (FIG. 41A), with the covers removed (FIG. 41B), and with one outer quarter-section removed (FIG. 41C).

FIGS. 42A-42C are section, exploded, and partially assembled views of a module for a metrocell assembly according to further embodiments of the invention.

FIGS. 42D-42G are section views of different modules for a metrocell assembly accordingly to alternative embodiments of the invention.

FIGS. 43A and 43B are perspective views of a metrocell assembly according to embodiments of the invention, wherein a cover is absent from FIG. 43B to illustrate the location where modules are joined.

FIG. 44 is an exploded perspective view of a clamping arrangement to join metrocell modules according to embodiments of the invention.

FIG. 45 is an exploded and assembled view of a clamping arrangement to join metrocell modules according to additional embodiments of the invention.

FIG. 46 is an exploded view of another clamping arrangement to join metrocell modules according to additional embodiments of the invention.

FIG. 47 is an exploded view of another clamping arrangement to join metrocell modules according to additional embodiments of the invention.

FIGS. 48A and 48B are exploded views of a further clamping arrangement to join metrocell modules according to additional embodiments of the invention.

FIGS. 49A and 49B are exploded and assembled views of another clamping arrangement to join metrocell modules according to additional embodiments of the invention.

FIGS. 50A and 50B are exploded and assembled views of a joining arrangement to join metrocell modules according to additional embodiments of the invention.

FIGS. 51A-C are exploded and assembled views of a joining arrangement to join metrocell modules according to additional embodiments of the invention.

FIGS. 52A-C are exploded and assembled views of the joining arrangement of FIGS. 51A-C used in conjunction with a module for a luminaire.

FIG. 53 is a perspective view of a clamping arrangement to join metrocell modules according to additional embodiments of the invention.

FIGS. 54A and 54B are exploded side and top views of a joining arrangement to join metrocell modules according to embodiments of the invention. FIG. 54C illustrates a joining arrangement that is a variation of the arrangement of FIGS. 54A and 5B.

FIGS. 55A-C are exploded side and top views of a joining arrangement to join metrocell modules according to further embodiments of the invention.

FIG. 56 is an exploded side section view of a joining arrangement to join metrocell modules according to further embodiments of the invention.

FIG. 57 is an exploded side view of a joining arrangement to join metrocell modules according to further embodiments of the invention.

FIG. 58 is a side section view of a joining arrangement to join metrocell modules according to further embodiments of the invention.

FIGS. 59A and 59B are side section views of joining arrangements to join metrocell modules according to further embodiments of the invention.

FIG. 60 is a top partial perspective view of a metrocell assembly according to additional embodiments of the invention.

FIG. 61 is a top partial perspective view of the metrocell assembly of FIG. 60 with the central pole extended.

FIGS. 62A and 62B are perspective views of the metrocell assembly of FIG. 60 showing a luminaire arm and a street sign mounted thereon, wherein covers for the luminaire arm are shown transparent in FIG. 62A and opaque in FIG. 62B.

FIG. 63 is an enlarged view of the assembly of FIG. 62A showing the mounting of the street sign.

FIG. 64 is an internal perspective view of the mounting plate and bracket for mounting the luminaire arm in the assembly of FIG. 62A.

FIG. 65 is an exploded perspective view of a base and power module for a metrocell assembly according to alternative embodiments of the invention.

FIG. 66 is an enlarged view of a door for the base and power module of FIG. 65.

FIG. 67 is a partially exploded view of a radio module for a metrocell assembly according to further embodiments of the invention with a first type of radio.

FIG. 68 is a partially exploded view of a radio module for a metrocell assembly according to further embodiments of the invention with a second type of radio.

FIG. 69 is a track cover for use with an accessory mounted in a track of a metrocell assembly according to embodiments of the invention.

FIG. 70 is an enlarged perspective view of a coupling section for the assembly of FIG. 62A that includes the luminaire arm.

FIG. 71 is a perspective view of a coupling section similar to that of FIG. 70 showing how cables can be routed between section of the metrocell assembly.

FIG. 72 is a top view of the coupling section of FIG. 71.

FIG. 73 is a perspective view of a bottom plate of a radio module for a metrocell assembly according to embodiments of the invention.

FIG. 74 is a perspective view of the radio module of FIG. 73 illustrating mounting plates for the radios.

FIG. 75 is a perspective view of another radio module with radios mounted thereon.

FIG. 76 is a perspective view of the radio module of FIG. 75 with an antenna module mounted above it.

FIGS. 77 and 78 are partial views of the upper portions of metrocell assemblies with concealed (FIG. 77) and unconcealed (FIG. 78) antenna modules.

FIG. 79 is a perspective view of a fully concealed radio module.

FIG. 80 is a perspective view of a partially concealed radio module.

FIG. 81 is an exploded top view of a module for a metrocell according to further embodiments of the invention.

### DETAILED DESCRIPTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”. “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

As used herein, phrases such as “between X and Y” and “between about X and Y” should be interpreted to include X and Y. As used herein, phrases such as “between about X and Y” mean “between about X and about Y”. As used herein, phrases such as “from about X to Y” mean “from about X to about Y”.

Well-known functions or constructions may not be described in detail for brevity and/or clarity.

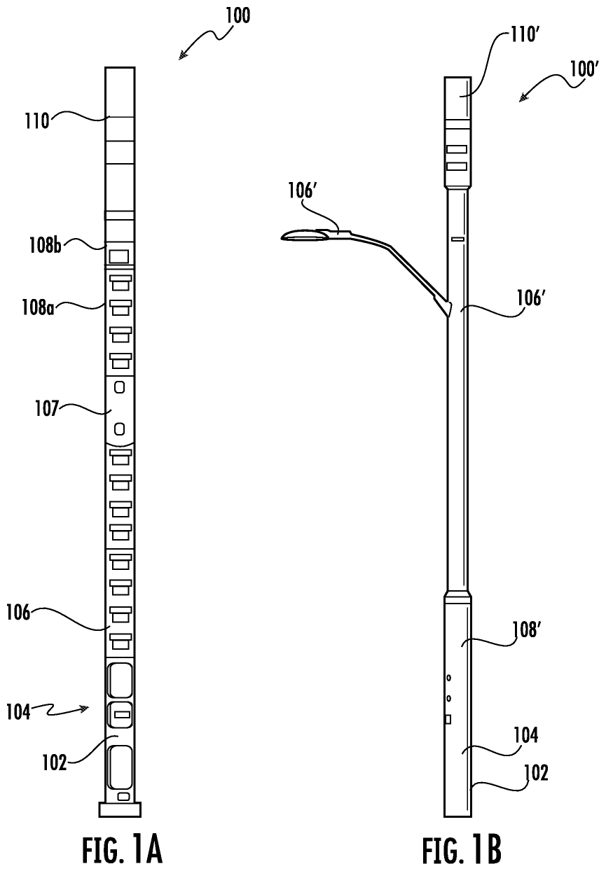

Referring now to the figures, FIGS. 1A and 1B illustrate exemplary prior metrocell assemblies 100, 100′, each of which utilizes a modular construction. Each of the metrocell assemblies 100, 100′ has a base 102 in which a power module 104 is enclosed. The metrocell assembly 100 has a luminaire module 106 located just above the power module 104, with two radio modules 108a, 108b above a spacer module 107 that is above the luminaire module 106. An antenna 110 is mounted atop the metrocell assembly 100. The metrocell assembly 100′ has an integrated radio assembly 108′ positioned just above the power module 104, a luminaire module 106 and accompanying luminaire 107 well above the radio module 108′, and an antenna 110′ above the luminaire module 106′. Details regarding these assemblies are included in the aforementioned documents that are incorporated by reference above and need not be repeated herein.

The assemblies 100, 100′ and variations thereof are typically employed in urban areas where streetlights and similar structures exist. Such structures may already be in place, such that the metrocell components are retrofitted onto an existing streetlight. Also, in some instances in which these structures are not already erected, local regulations determine the appearance of the structures, which can limit the degree of variability permitted in the arrangement of modules. However, it may be desirable to provide metrocell assemblies with luminaires in other environments, such as public arenas, university campuses, office parks, corporate campuses, and the like. Below are described metrocell assemblies that may be appropriate and/or desirable for such environments.

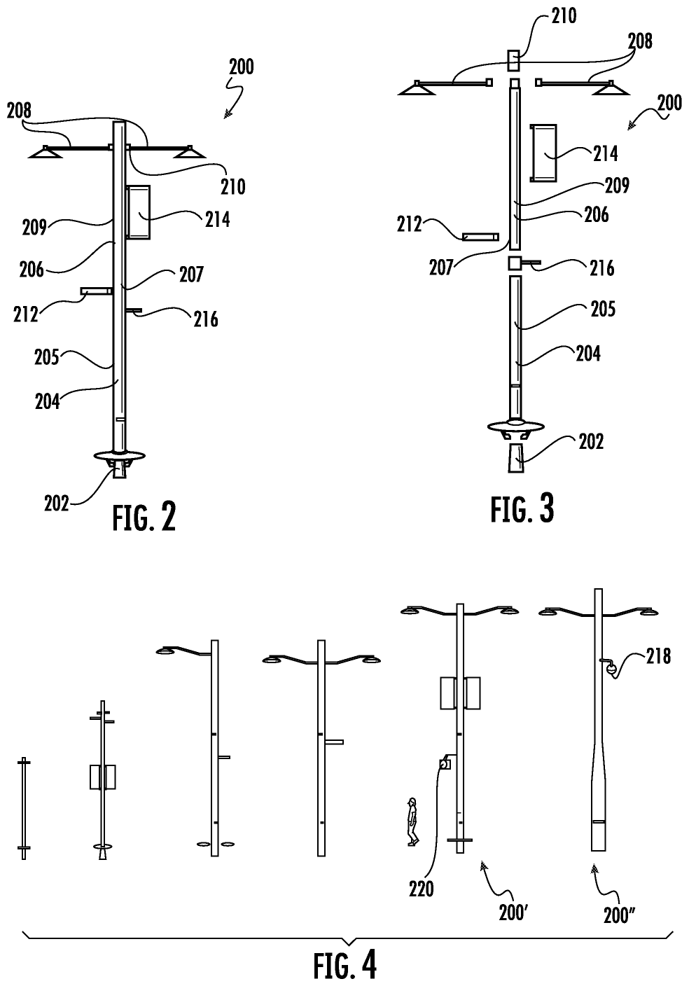

An exemplary embodiment of a metrocell assembly is illustrated in FIGS. 2 and 3 and is designated broadly at 200. The metrocell assembly 200 includes a frusto-conical base 202, a lower module 204 that includes a cellular radio (not shown) within a cylindrical housing 205, an upper module 206 having a cylindrical housing 209 that includes two longitudinally-extending power rails 207, two luminaires 208, and an antenna module 210. As illustrated in FIGS. 2 and 3, the metrocell assembly 200 also has a street sign 212 mounted in one of the power rails 207, and a banner 214 is mounted in the other power rail 207. A pedestrian light 216 is mounted between the lower and upper modules 204, 206. These structures are described in greater detail below.

Within the base 202, the lower module 204, and the upper module 206, various pieces of equipment that are needed or desired to operate the metrocell are included. Exemplary equipment includes batteries, other power sources and/or carriers, controllers, rectifiers, distribution units, fans, and the like. The modular construction can enable the designer to select design details for the metrocell assembly 200 as desired, including the locations of various of these pieces of equipment.

In addition, the presence of the power rails 207 can provide the flexibility to add, omit, retrofit, etc., accessories such as those described above (e.g., the street sign 212 and the banner 214) and others described below. The power rails 207 are configured to receive power from a power source within the metrocell assembly 200 (e.g., a power module containing a battery, or an on-site power source) and provide mounting locations for the various accessories such that mounting of the accessory connects the power source to the accessory. This may be achieved by establishing electrical contact between contacts on the accessory and locations along the power rail 207 that in turn connect the accessory to the power source. As one example, the power rails 207 may include exposed contacts on either side of the power rail 207 onto which the accessory can slide, latch, clamp or the like. A single power rail 207 may provide power to multiple accessories at once if they are mounted one above the other on the power rail 207.

FIG. 4 illustrates some exemplary configurations of the metrocell assemblies 200, of different heights and with different accessories, that can be created from 6′ and 12′ versions of the modules 202, 204, 206 discussed above. For example, metrocell assembly 200′ has a crosswalk light 220 mounted thereon, and metrocell assembly 200″ has a security camera 218 mounted thereon.

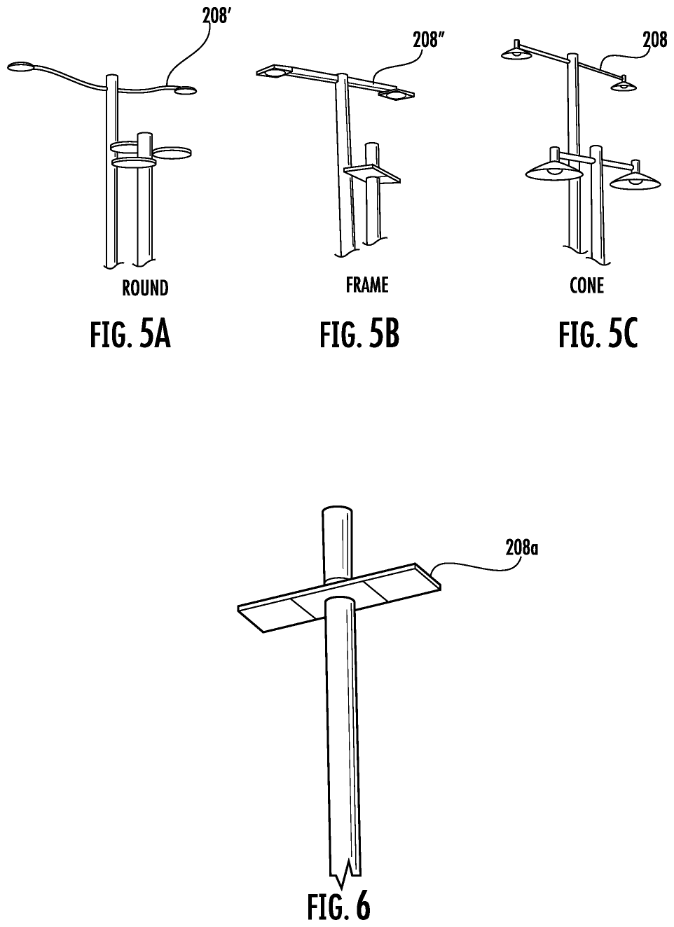

FIGS. SA-5C illustrate three different styles of luminaires that may be employed with the metrocell assembly 200. FIG. 5A illustrates a circular-style luminaire 208′. FIG. 5B illustrates a rectangular-or “frame”-style luminaire 208″. FIG. 5C illustrates a cone-style luminaire 208. FIG. 6 illustrates a frame-style luminaire 208a with arms that are essentially the same width as the lighting portion of the luminaire.

FIG. 7 illustrates a cone-style luminaire 208 that is attached to the metrocell assembly 200 via a clamp arrangement 230. The clamp arrangement 230 has two semi-cylindrical clamp members 231, 232. A recessed section 206a extends upwardly from the upper module 206 and provides a mechanism for attachment of the antenna module 210. The clamp members 231, 232 overlie the recessed section 206a to provide a flush surface between the upper module 206 and the antenna module 210. The clamp members 231, 232 can be attached to each other and/or to the recessed section 206a via any number of techniques, including threaded fasteners, adhesives, tongue-in-groove features, and the like. Notably, the recessed section 206a of the upper module 206 includes a cutout area 233. The cutout area 233 allows access to a technician to connect power from the interior of the upper module 206 to the luminaire 208 (typically through the luminaire arm 208b).

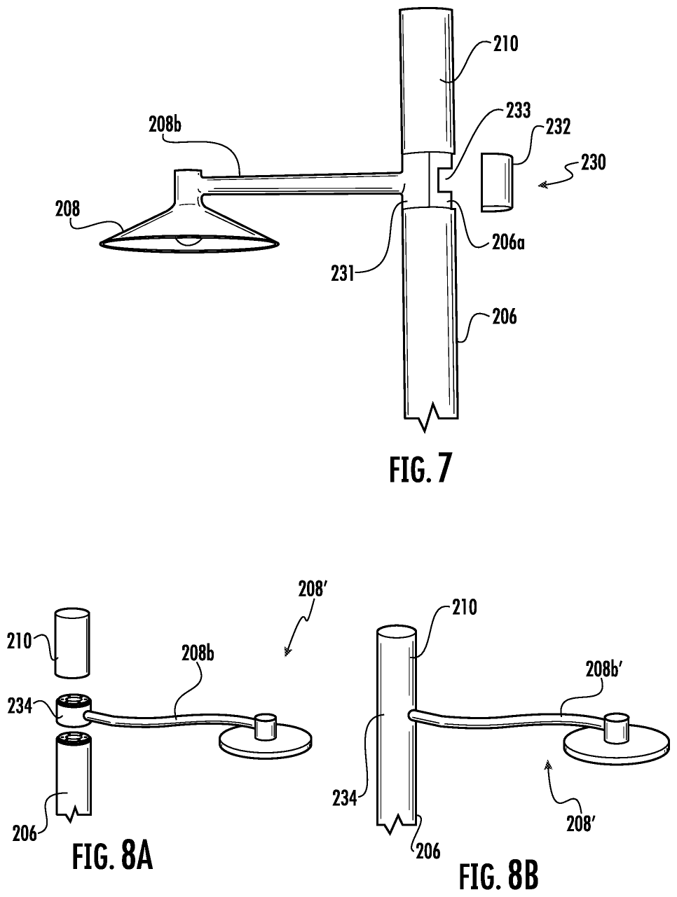

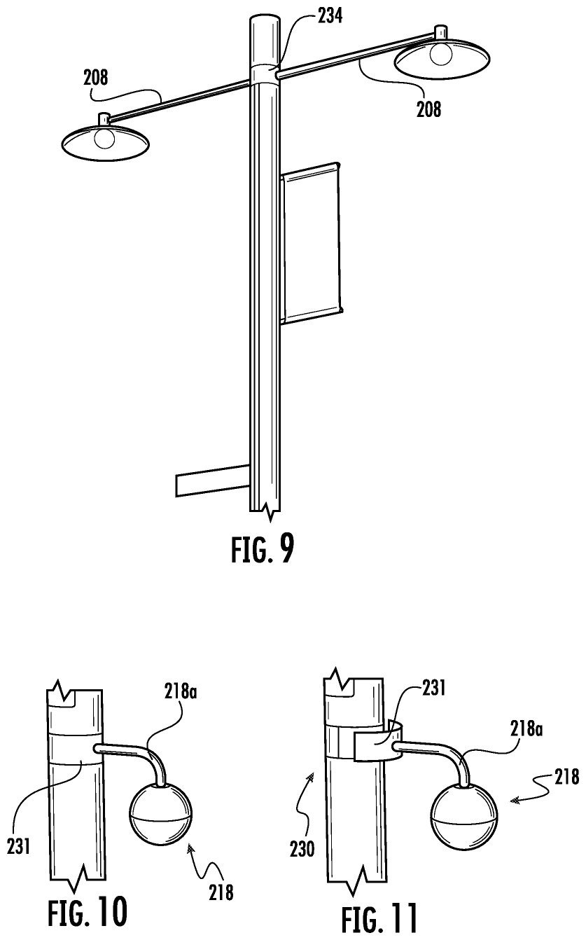

An alternative configuration for mounting luminaires is shown in FIGS. 8A and 8B, wherein a circular-style luminaire 208′ is shown attached to a sleeve 234. The sleeve 234 is disposed between the upper module 206 and the antenna module 210. In this configuration power is routed from the interior of the upper module 206 into the sleeve 234, then to the luminaire 208′ through the arm 208b. FIG. 9 shows a similar sleeve-mounting arrangement that supports two separate luminaires 208.

As suggested above, in addition to luminaires the metrocell assembly 200 may also include other accessories. Some of these are discussed below, along with exemplary attachment methods.

FIGS. 10 and 11 illustrate a typical security camera 218 mounted via a clamp arrangement 230. The security camera 218 is attached (typically via welding) to the clamp member 231 with an arm 218a. Power and communications cables can be routed to the camera 218 through the arm 218a.

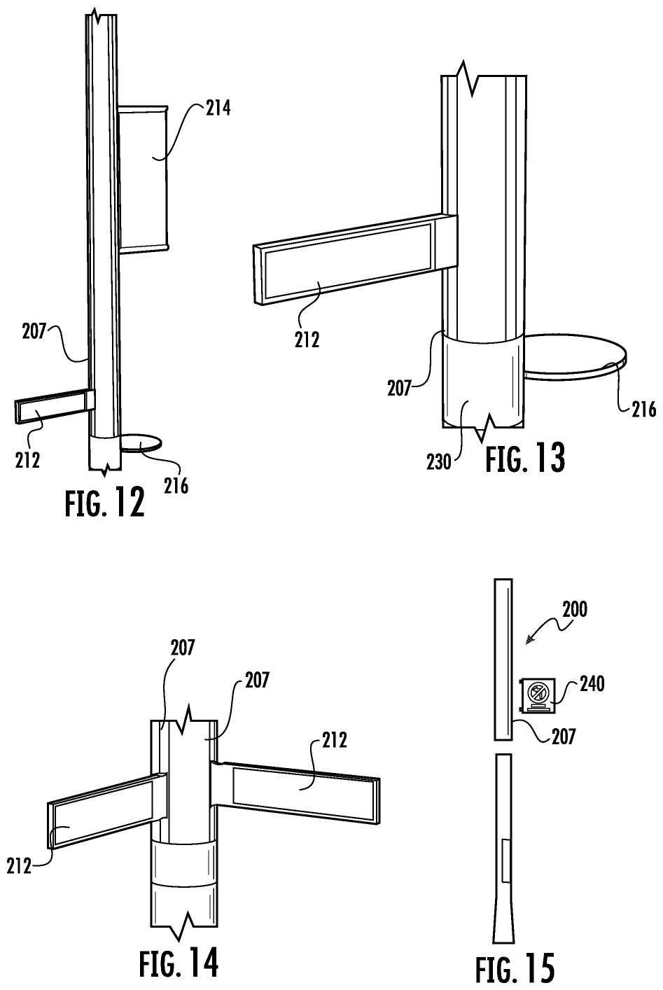

FIGS. 12 and 13 illustrate an upper portion of the upper end of the metrocell assembly 200. The street sign 212 seen therein is attached via a power rail 207, and the banner 214 is mounted in another power rail 207, but is not connected for power. FIG. 13 illustrates the street sign 212 mounted in the power rail 207. The pedestrian light 216 is mounted via a clamp arrangement 230. FIG. 14 illustrates two street signs 212 mounted in power rails 207 that are separated on the circumference of the upper module 206 by about 90 degrees. The street signs 212 may be power or unpowered; if powered, the street signs 212 may be supplied with power via the power rails 207. Separation of the power rails 207 by 90 degrees may be particularly useful for the mounting of street signs at an intersection of streets.

FIG. 15 illustrates the metrocell assembly 200 with a traffic sign 240 mounted thereto. As shown, the traffic sign 240 is mounted in the power rail 207, which can provide power thereto.

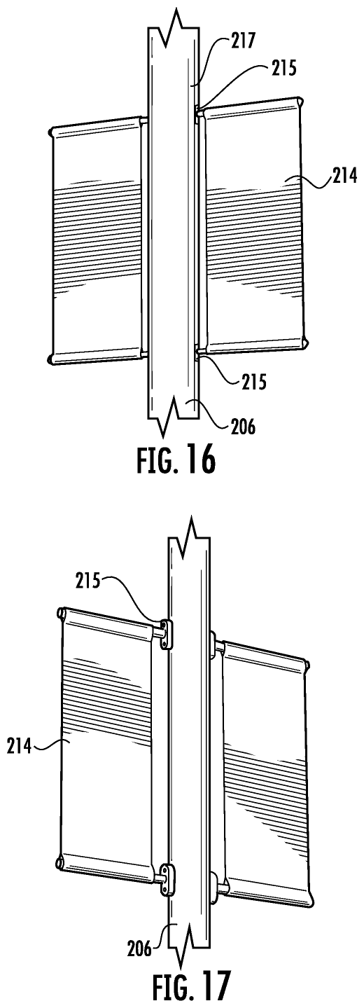

FIGS. 16 and 17 illustrate different ways in which a non-illuminated banner 214 may be mounted. FIG. 16 shows the banner 214 mounted via brackets 215 that is inserted into the power rail 207; filler rods 217 can then be employed to fill the remainder of the open space of the power rail 207. FIG. 17 illustrates the banner 214 being mounted directly to the exterior of the upper module 206, with the brackets 215 being bolted to the exterior surface.

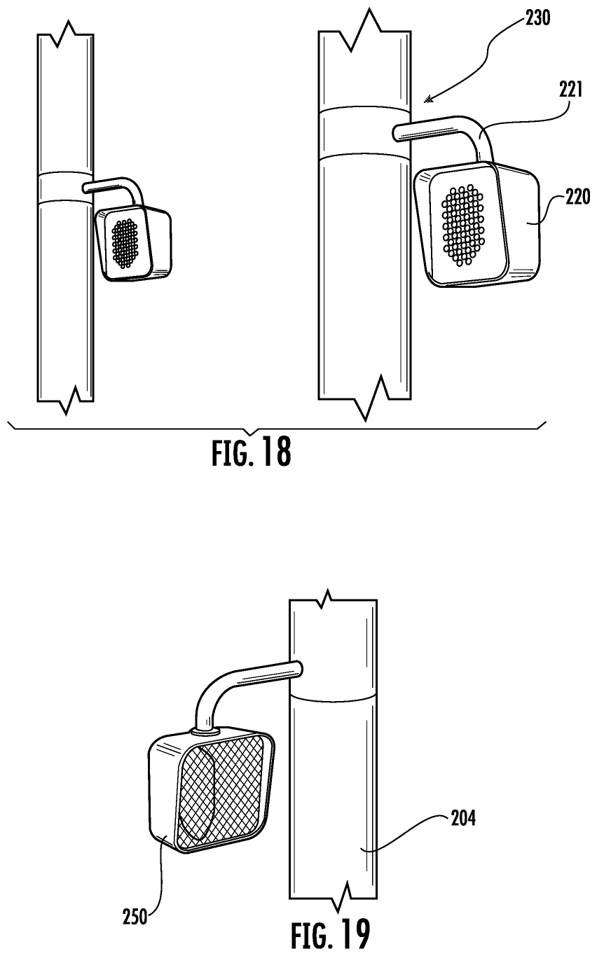

FIG. 18 illustrates a crosswalk light 220 mounted to the metrocell assembly 200 via a clamping mechanism 230 such as that described above. Power can be supplied to the crosswalk light 220 from the interior of the metrocell assembly 200 through the arm 221. FIG. 19 illustrates a crosswalk sign 250 that can be mounted to the metrocell assembly 200. In this instance, the crosswalk sign 250 is welded directly to the exterior of the lower module 204.

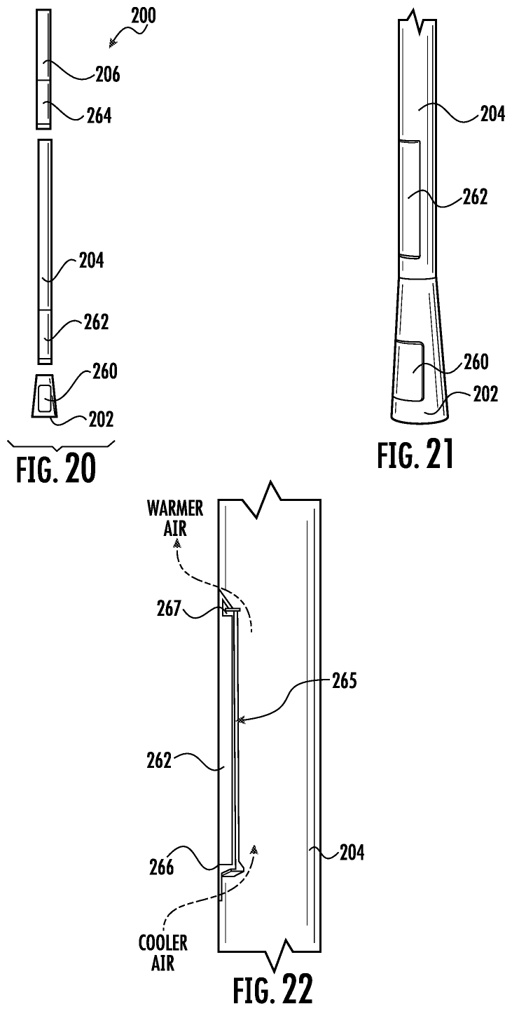

FIGS. 20-22 illustrate the metrocell assembly 200 with doors 260, 262, 264 in the base 202, lower module 204 and upper module 206, respectively. Each of the doors 260, 262, 264 is positioned near the lower end of its host structure to facilitate access for a technician to components stored therein. As exemplified in FIG. 22, the door 262 shown therein is sized relative to the window 265 that it covers so that gaps 266, 267 are present above and below the upper and lower edges of the door 262. The gaps 266, 267 permit external air to flow from the environment through the lower gap 266, upwardly within the lower module 204, and out through the upper gap 267 (this is illustrated via the arrows in FIG. 22). Such air flow can provide cooling to components stored within the lower module 204. Gaps above and below the doors 260, 264 can similarly provide cooling to the base 202 and upper module 206.

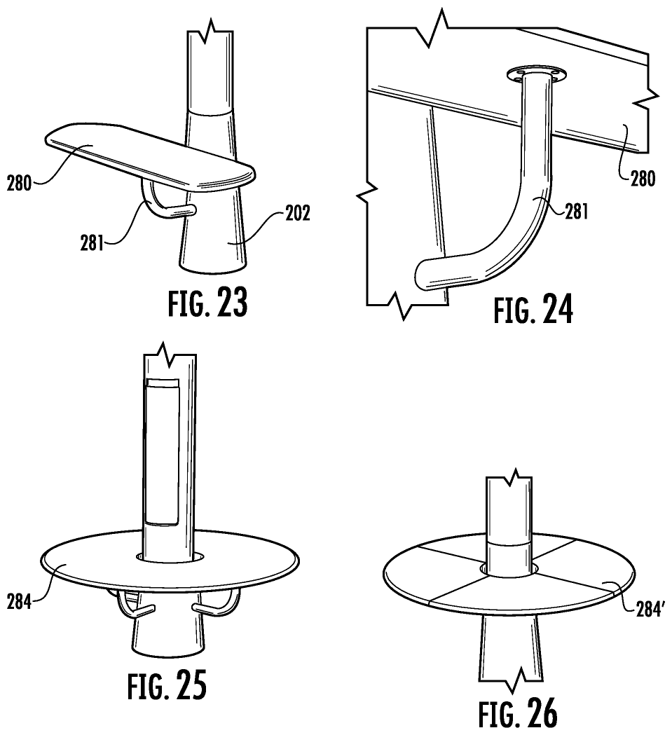

FIGS. 23 and 24 illustrate a bench 280 mounted to the base 202 for pedestrians to rest, congregate, and the like. The bench 280 is mounted to the base 202 via an arm 281 that is bolted to the underside of the bench 280 and welded to the side of the base 202. FIG. 25 illustrates an alternative metallic circular bench 284 mounted to the base 202. FIG. 26 illustrates an alternative circular bench 284′ formed of cement.

The metrocell assemblies described above may, of course, include or omit any of the accessories described above. The presence of the power rails 207 may provide designers and engineers with extreme flexibility to include the desired accessories (if any) based on the desires of the end user. Such flexibility may be particularly desirable in supplying metrocell assemblies to environments such as public arenas, university campuses, office parks, corporate campuses, and the like, each of which may have its own specifications based on its functional and aesthetic needs.

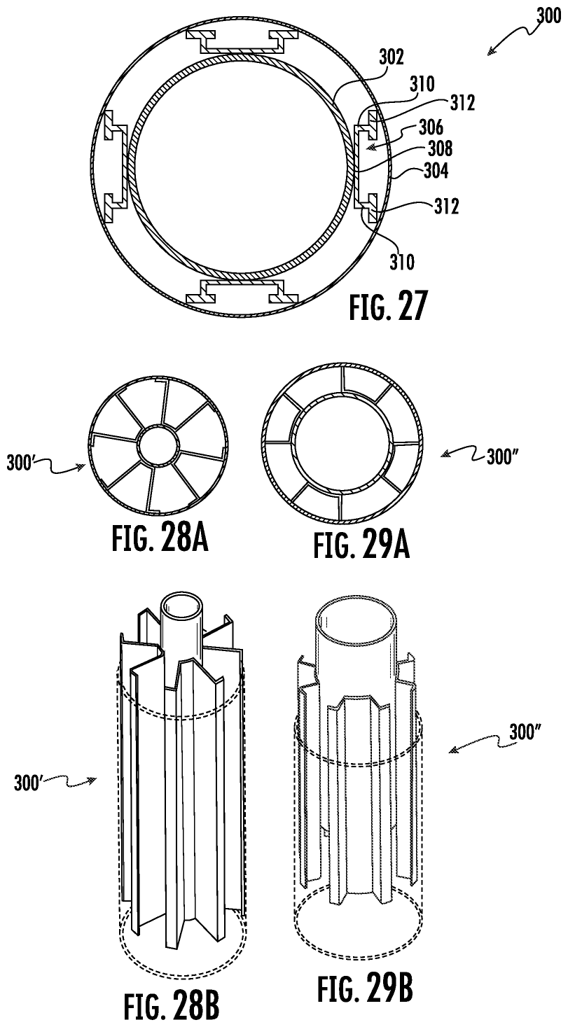

Some more detailed concepts on the construction of the metrocell assembly 200 are illustrated in FIGS. 27-59 and are discussed below.

Referring to FIG. 27, a metrocell module 300 is shown therein that includes an internal pole 302, an external cover 304 (which may be in sections, such as halves or quarters, and may be sheet metal), and U- or V-shaped tracks or rails 306 that are positioned between the pole 302 and the cover 304. The tracks 306 have a base 308 that contacts the pole 302, arms 310 that extend radially outward from the base 308, and feet 312 at the ends of the arms 310 that contact the inner surface of the cover 304. This arrangement can utilize a smaller, lighter central pole for the module 300 while providing a module of the same diameter. Variations in the configuration with different sized poles and tracks are shown in the module 300′ of FIGS. 28A-B and the module 300″ of FIGS. 29A-B. In addition to providing structural support, the tracks 306 may also define pathways for cable routing, power rails or the like.

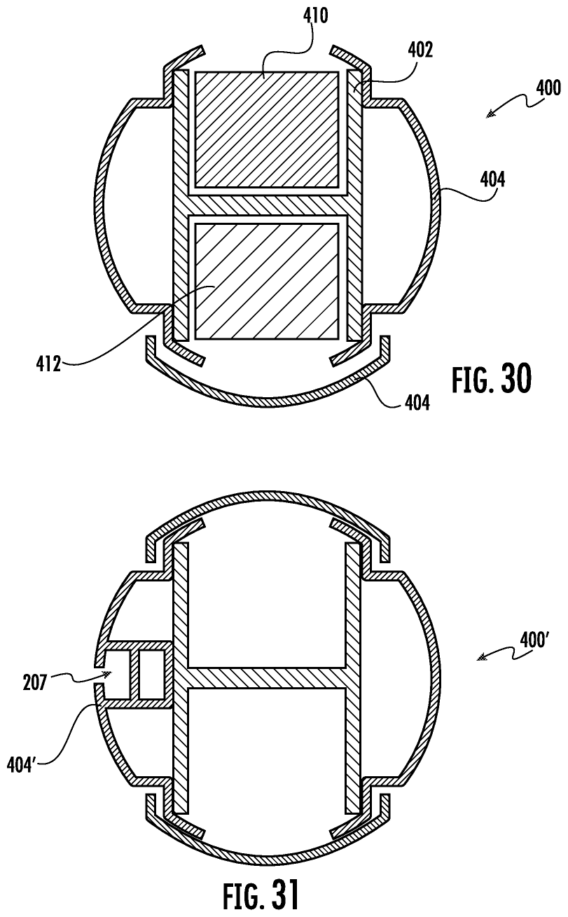

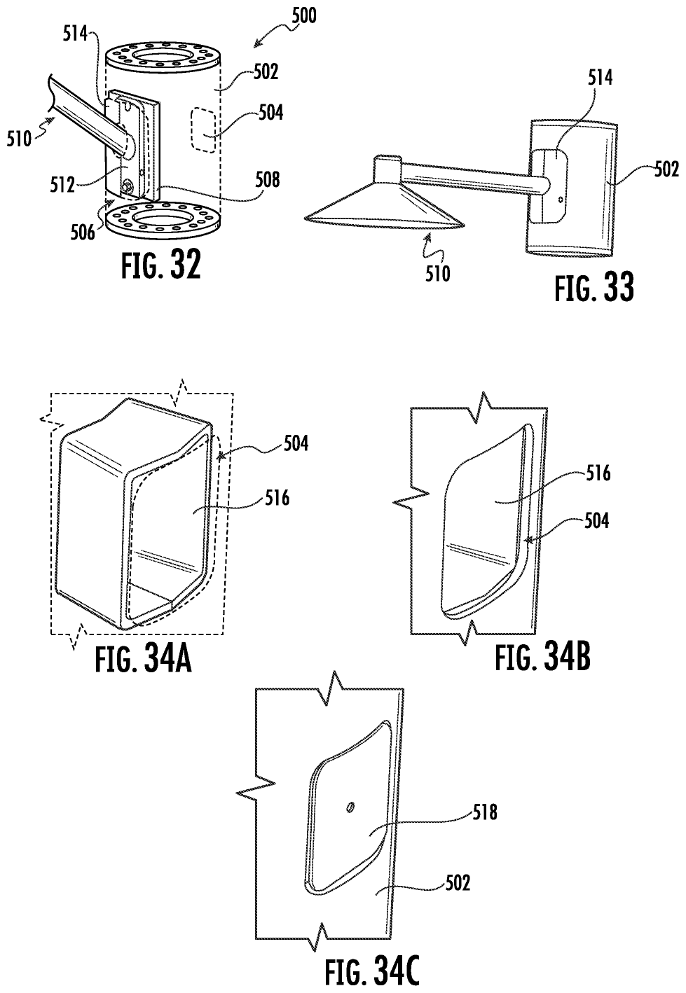

FIGS. 30 and 31 illustrate modules 400, 400′ that utilize an internal skeletal frame (such as the H-shaped frame 402 shown therein) as the internal load-bearing member (typically steel or FRP), and quarter sections 404 that serve as an external cover. The cover sections 404 may have features that facilitate attachment to either the frame 402 or to each other. As shown in FIG. 30, the internal spaces defined by the “H” of the frame 402 may serve as locations for the mounting of an RRU 410, a power supply 412, or other equipment. As shown in FIG. 31, one or more of the cover sections 404′ may include features that can receive a power rail as described above at 207.

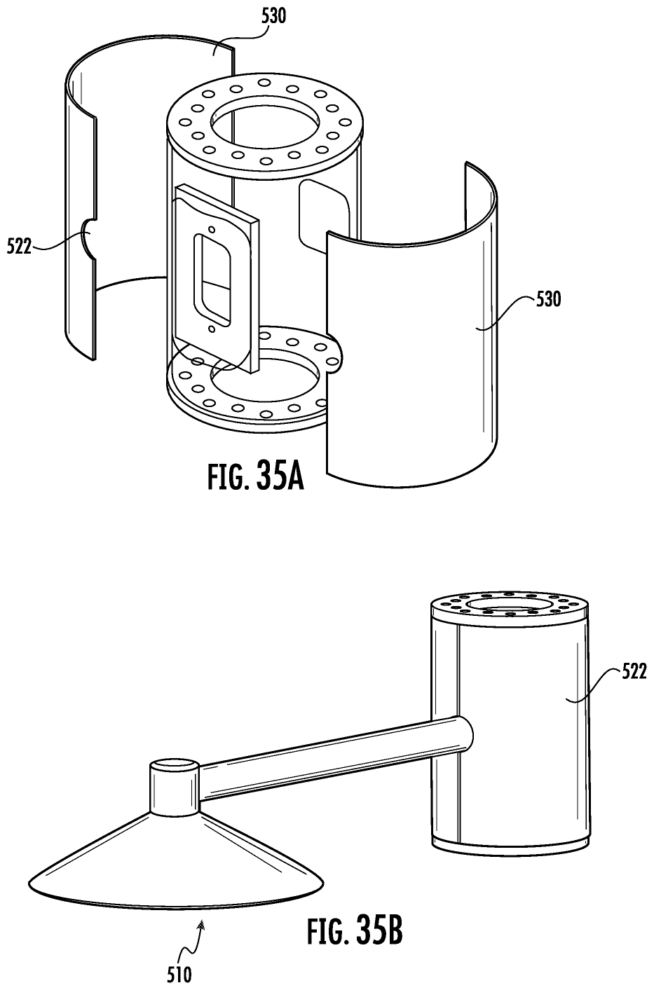

FIGS. 32-35B illustrate a luminaire module 500 that includes a cylindrical foundation 502 with a hand hole 504 and a mounting hole 506 formed on opposite sides thereof. A mounting plate 508 is mounted to the inner surface of the foundation 502 radially inward of the mounting hole 506 to serve as an attachment point for a luminaire unit 510. The base 512 of the luminaire unit 510 is mounted to the mounting plate 508, and covers 514 overlie the base 512 within the mounting hole 506 to provide a smooth overall outer surface for the module 500. As shown in FIGS. 34A-C, a reinforcing guide 516 is mounted to the foundation 502 radially inwardly of the hand hole 504. A cover 518 overlies the guide 516 and covers the hand hole 504. The hand hole 504 thus provides access to a technician during installation or maintenance of the luminaire unit 510. As an alternative, FIGS. 35A and 35B show overall cover halves 530 that overlie the entire foundation 502 with the exception of small cutouts 522 for the arm of the luminaire unit 510.

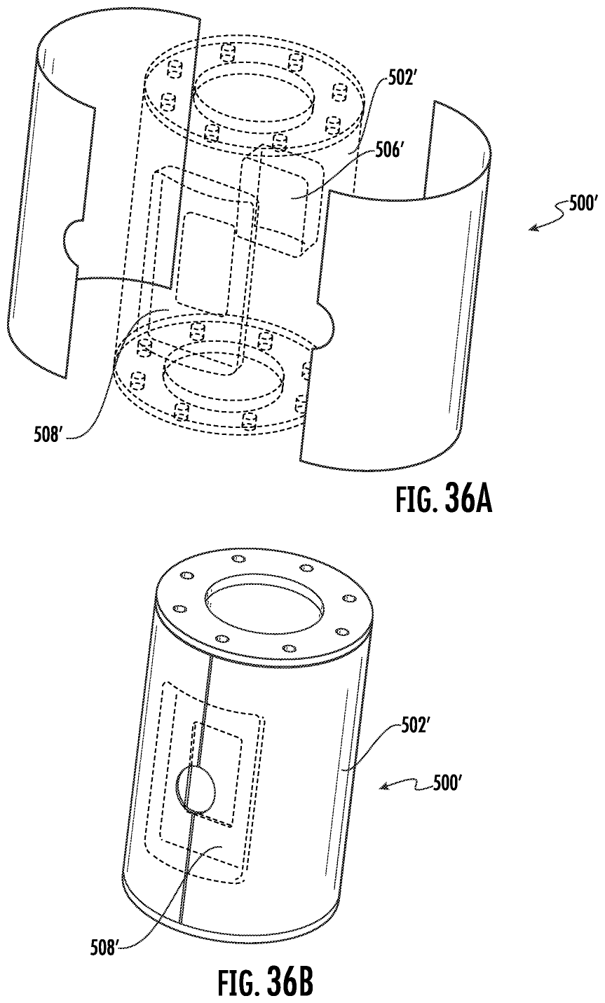

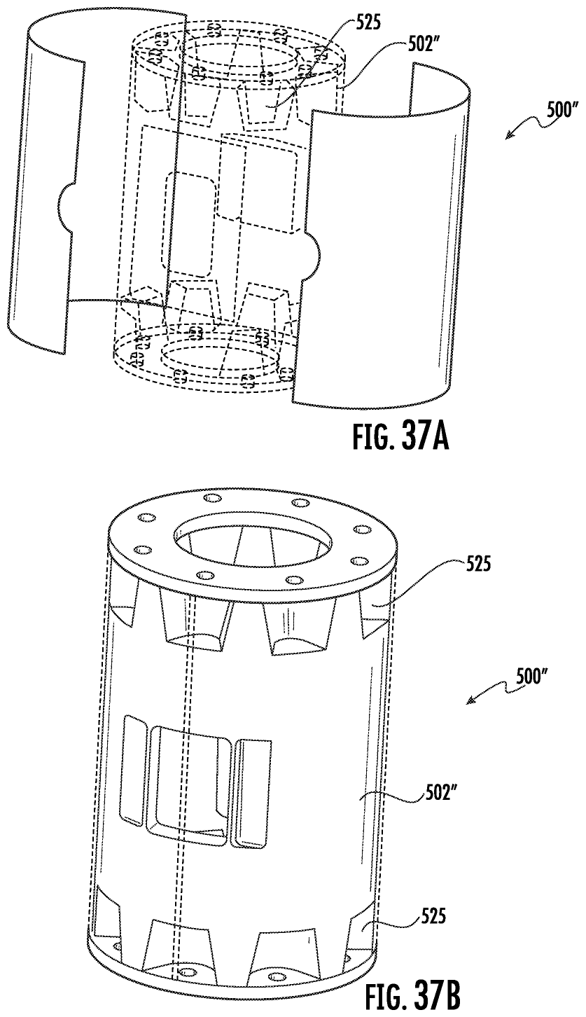

An alternative embodiment of a luminaire module 500′ is shown in FIGS. 36A-B, in the module 500′, the foundation 502′ is cast, with the mounting plate being omitted and a mounting area 508′ and a hand hole 506′ being cast directly into the foundation 502′. Another luminaire module 500″ is illustrated in FIGS. 37A-B; the luminaire module 500″ is similar to the module 500′, but cutout areas 525 are cast into the upper and lower ends of the foundation 502″ to provide access to the holes in the mounting rings on the upper and lower end of the foundation 502″.

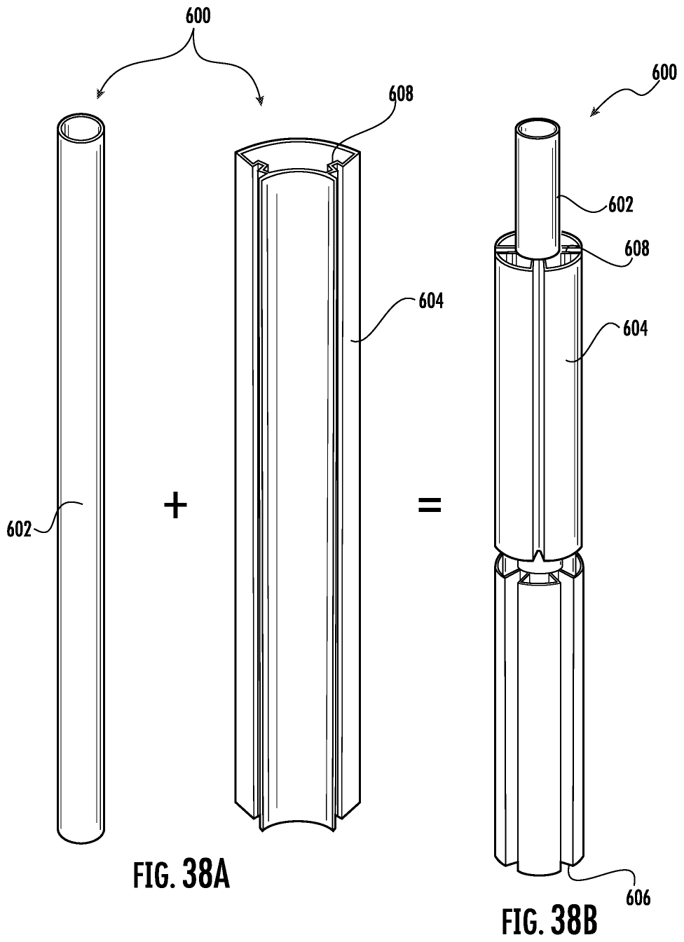

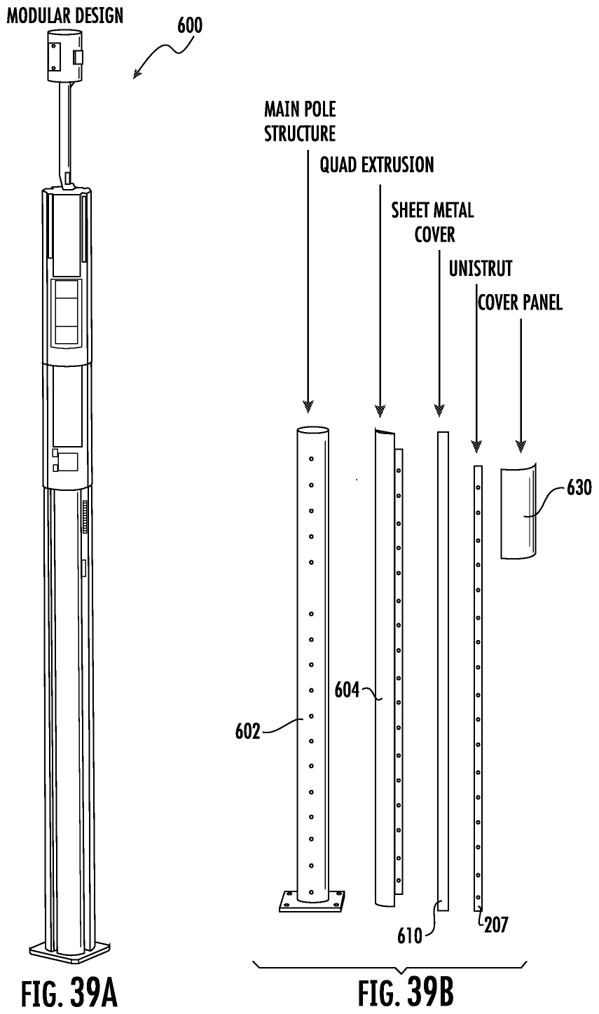

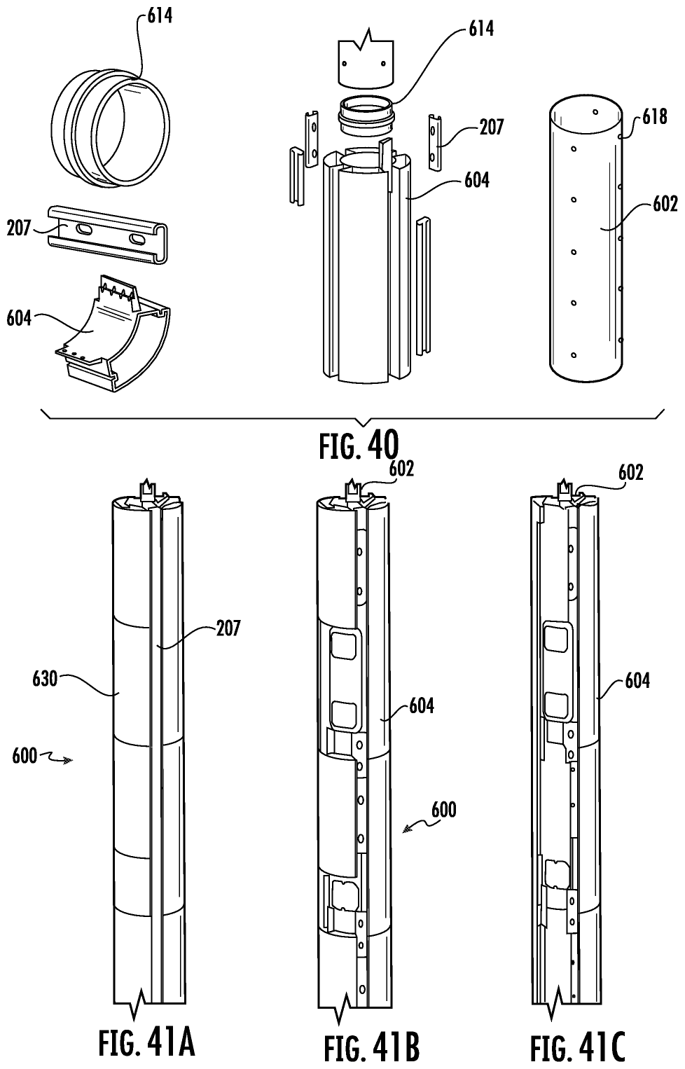

Referring now to FIGS. 38A-B, an embodiment of a section of a pole for a metrocell assembly, designated broadly at 600, is shown therein. The section 600 includes an interior pole 602 and four hollow outer quarter-sections 604 (formed, for example, by bending sheet metal or extruding aluminum) mounted to the pole 602 such that gaps 606 are present between adjacent outer quarter-sections 604. The gaps 606 may house power rails 207 as are discussed above. The outer quarter-sections 604 may be mounted to the pole 602 in any manner; herein pins 608 are illustrated that are received in holes 618 in the pole 602 (the holes 618 can be seen in FIG. 40). FIGS. 39A-B illustrate the pole section 600 and also show the power rails 207, which may be covered with an elongate cover 610. FIG. 40 provides another view of the pole section 600 and illustrates a cylindrical coupler 614 with a raised ridge 616 that may be used to join two pole sections 600 together. FIGS. 41A-C show joined pole sections 600 with external covers 630 covering various access holes (FIG. 41A), with the covers removed (FIG. 41B), and with one outer quarter-section 604 removed (FIG. 41C).

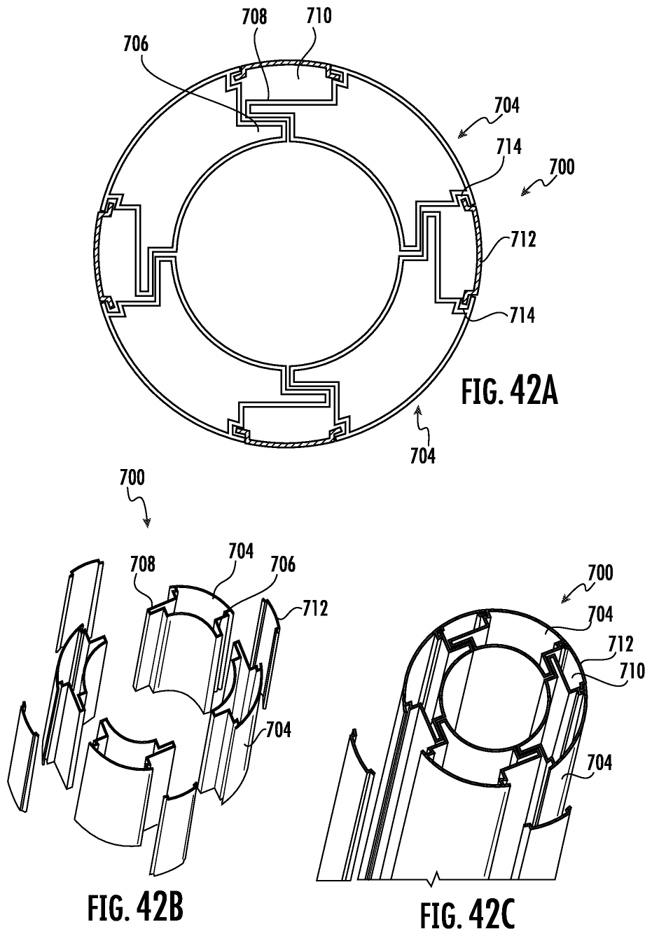

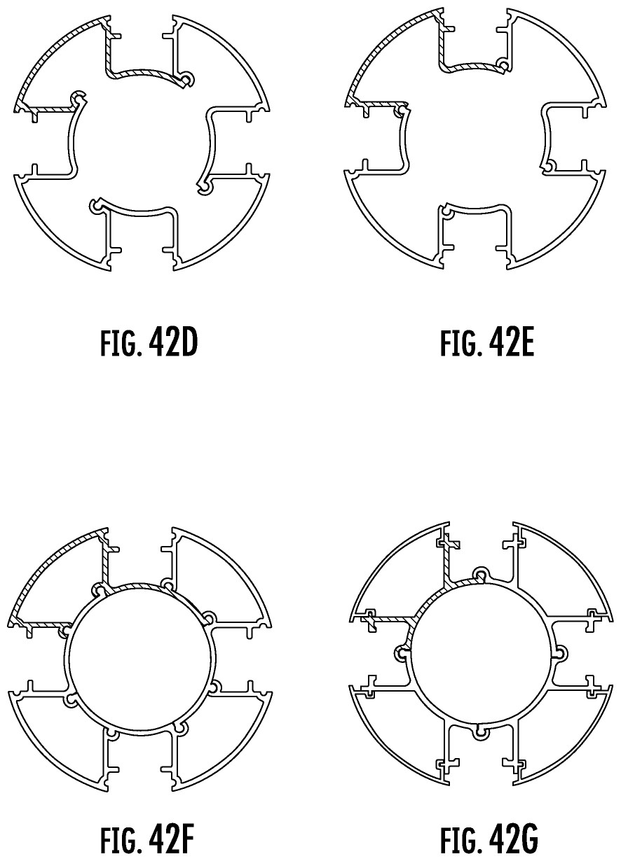

FIGS. 42A-C illustrate a pole section 700 that has no internal pole, but instead is formed of four interlocking quarter-sections 704. Each quarter-section 704 has protrusions 706, 708 on opposite longitudinal edges that engage the protrusions 708, 706 of adjacent quarter-sections. A gap 710 is present radially outward of each protrusion 708 that can house a power rail 207. Covers 712 may be employed to overlie the gaps 710 to protect the power rails, with their edges fitting within recesses 714 within each gap 710.

FIGS. 42D-42G illustrate alternative designs of quarter-sections. FIG. 42D shows a module 720 with quarter sections 721, each of which has an outer wall 722 and two track walls 724, 726 that extend radially inwardly therefrom. The track wall 724 has a small clip 725. An inner wall 727 extends circumferentially away from the track wall 726 and terminates in a bead 728 that is configured to fit within the clip 725 of the adjacent quarter-section 720. Thus, it can be seen that four quarter-sections 720 can fit together to form a module 721 with gaps 729. Also notable are flanges 722a, 724a that extend from respective track walls 722, 724 into the gaps 729, and indentations 722b, 724b in the inner walls 722, 724 that are configured to receive covers for the gaps 729.

FIG. 42E shows an alternative module 730 formed of quarter-sections 732. The quarter-sections 732 are similar to the quarter-sections 722, with the exception that the clip 735 extends away from the opposite track wall 734, and the bead 738 is located on the inner wall 737 to mate correctly with the clip 735.

FIG. 42F shows a further alternative module 740 formed of quarter-sections 742. The quarter-sections 742 are similar to the quarter-sections 732 with the exceptions that (a) each tracking wall 744, 746 has a clip 745, (b) the inner wall 747 extends farther circumferentially, and (c) the inner wall has two beads 747 that are positioned to be received in the clips 745 of the adjacent quarter-section 742. This arrangement enables the quarter-sections 742 to form a module 740 that has a complete inner cylinder C formed by the inner walls 747. The presence of the cylinder C may provide the module 740 with additional strength and stiffness.

FIG. 42G shows another alternative module 750 formed of quarter-sections 752. Each quarter-section 750 has no outer wall, but has an inner wall 757 with circumferential extensions 757a, one of which terminates in a clip 755 and the other of which terminates in a bead 758. The clip 755 of one quarter-section 752 receives the bead 758 of the adjacent quarter-section 752, with the result being a full inner cylinder C′ as described above. The module 750 also employs separate covers 759 in lieu of outer walls on the quarter-sections 752.

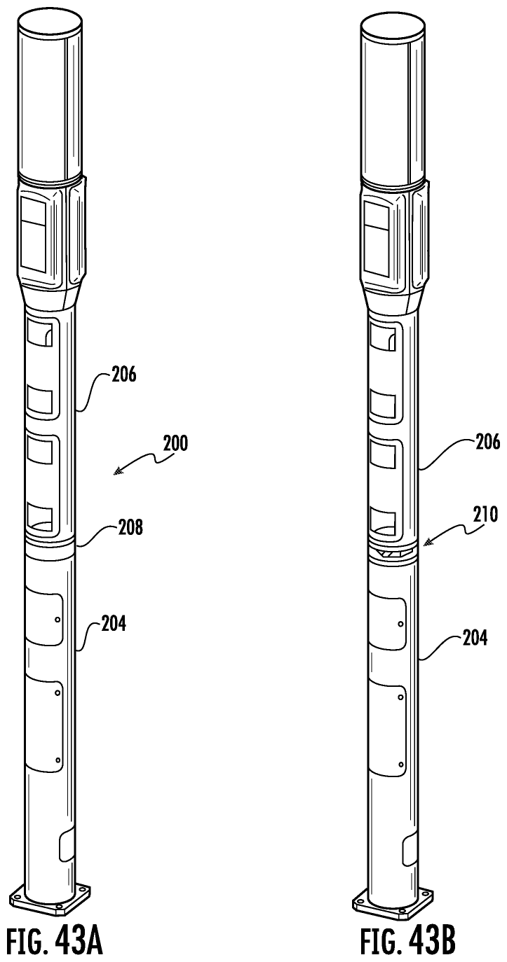

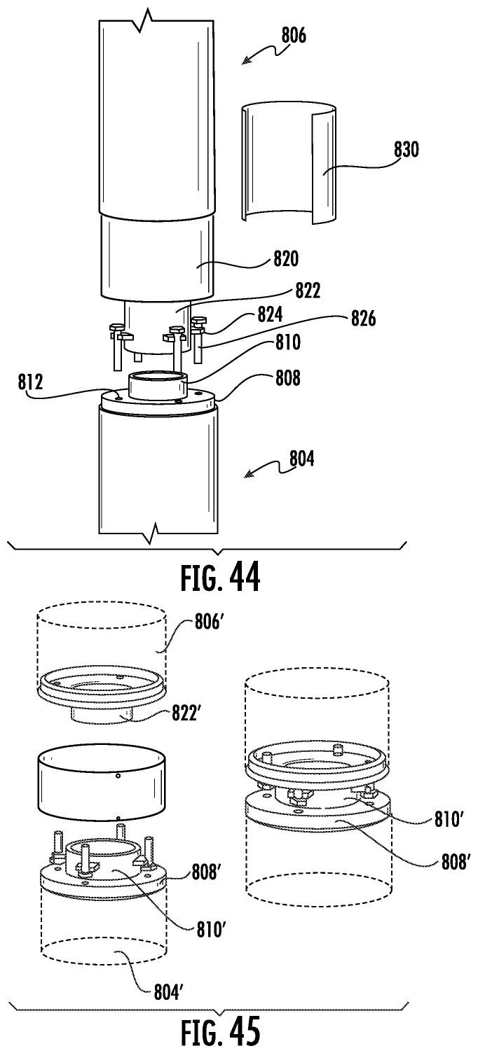

Referring now to FIGS. 43A-B, the metrocell 200 is shown therein with lower and upper sections 204, 206 stacked on top of each other, with a ringed cover 208 overlying the gap 210 between the sections 204, 206. FIGS. 44-59 illustrate different techniques for joining two sections 204, 206 to each other and/or to other modules. Thus, any reference herein to a section of the metrocell assembly may equally apply to a specific module of a metrocell assembly.

FIG. 44 illustrates two sections 804, 806 being joined via a clamping technique. The lower section 804 has a plug 808 with a ring 810. The plug 808 has threaded holes 812. The upper section 806 has a plug 820 with a larger ring 822. Flanges 824 extend radially outwardly from the larger ring 822. The sections 804, 806 are joined by lowering the section 806 onto the section 804, with the larger ring 822 fitting around the smaller ring 810. The sections 804, 806 are secured with bolts 826 that are inserted through holes in the flanges 824 and into the holes 812. Covers 830 (one of which is shown in FIG. 44) are then applied to cover the gap between the sections 804, 806.

FIG. 45 illustrates a similar joining technique, but with the plug 808′ with the larger ring 810′ and the bolts on the lower section 804′ and the smaller ring 822′ and threaded holes on the upper section 806′.

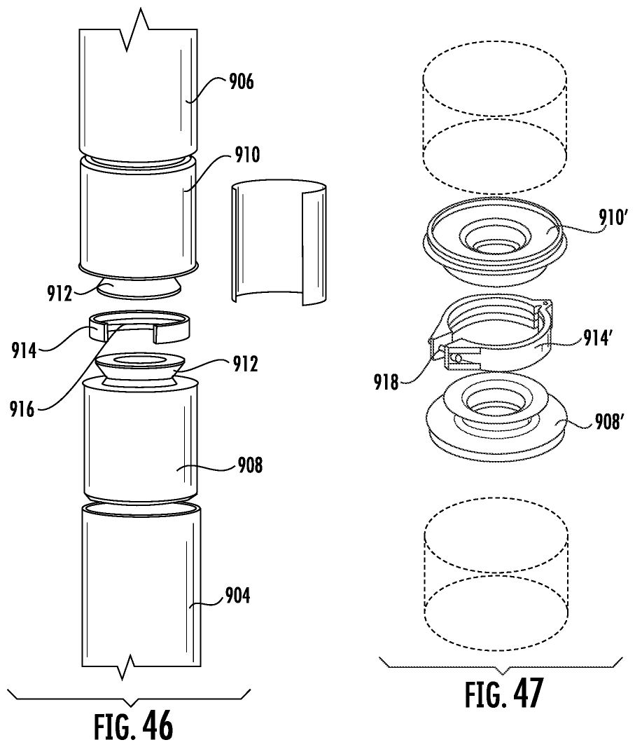

FIG. 46 illustrates the joining of two sections 904, 906. Two identical plugs 908, 910 are inserted into the ends of the sections 904, 906. Each of the plugs 908, 910 includes a frustoconical projection 912 that widens toward its free end. An annular clamp 914 with a circumferential groove 916 on its inner surface fits around the projections 912 to secure them in place. FIG. 47 illustrates a slightly different embodiment, wherein the plugs 908′, 910′ are shorter longitudinally, and the clamp 914′ is hinged and able to be tightened via a tightening bolt 918.

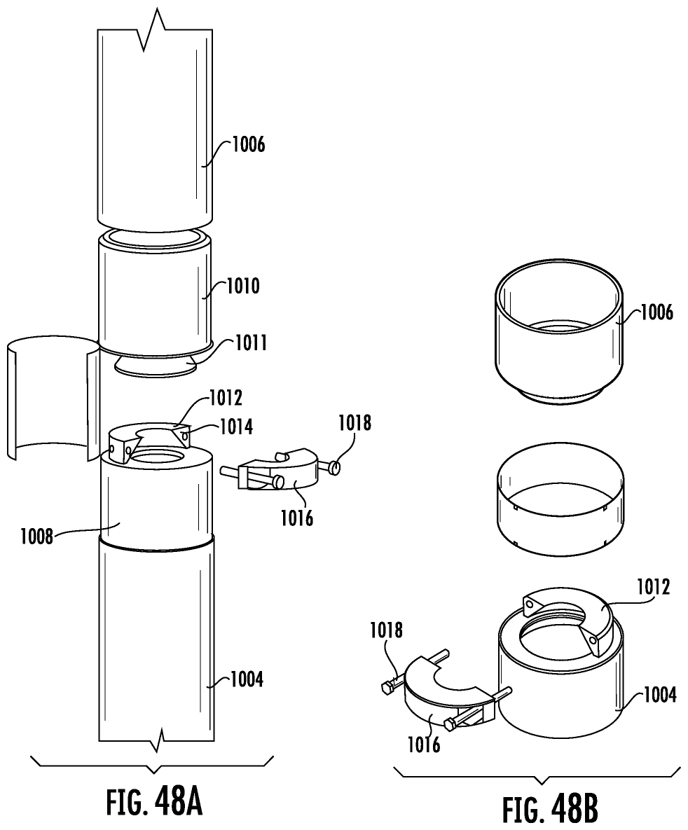

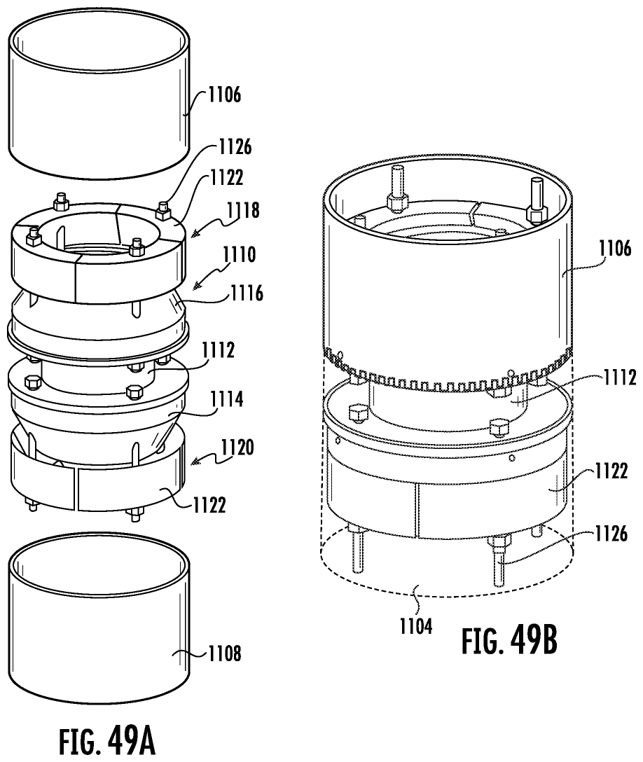

Another variation is shown in FIGS. 48A and 48B, in this embodiment, the section 1004 receives a plug 1008 that has a semi-ring 1012 attached to one end. The semi-ring 1012 has an angled surface 1014. A plug 1010 is received in the upper section 1006; the plug 1010 has a frustoconical projection 1011. To join the sections 1004, 1006, the projection 1011 is slid horizontally to engage the angled surface 1014. A mating semi-ring 1016 is then fastened into place on the semi-ring 1012 with bolts 1018, which secures the sections 1004, 1006 together.

FIGS. 49A-B illustrate another joining technique. In this embodiment, lower section 1104 is joined to upper section 1106 via a cone clamping unit 1110. The cone clamping unit 1110 includes a base 1112 with frustoconical ends 1114, 1116. Upper and lower rings 1118, 1120 each include four quarter-rings 1122 with angled inner surfaces 1124. Bolts 1126 extend through each quarter-ring 1122 and into one of the ends 1114, 1116. Tightening of the bolts 1126 draws each quarter-ring 1122 toward its respective end 1114, 1116; once the inner surface 1124 of the quarter-ring 1122 engages the end 1114, 1116, the quarter-ring 1122 is forced radially outwardly against the inner surface of the respective section 1104, 1106. This action both mounts the cone clamping unit 1110 to the sections 1104, 1106 and joins the sections 1104, 1106 together. One potential advantage of this arrangement is the ability to attach the clamping unit 1110 to the sections on site; this can enable an installer to cut the sections 1104, 1106 to length on-site.

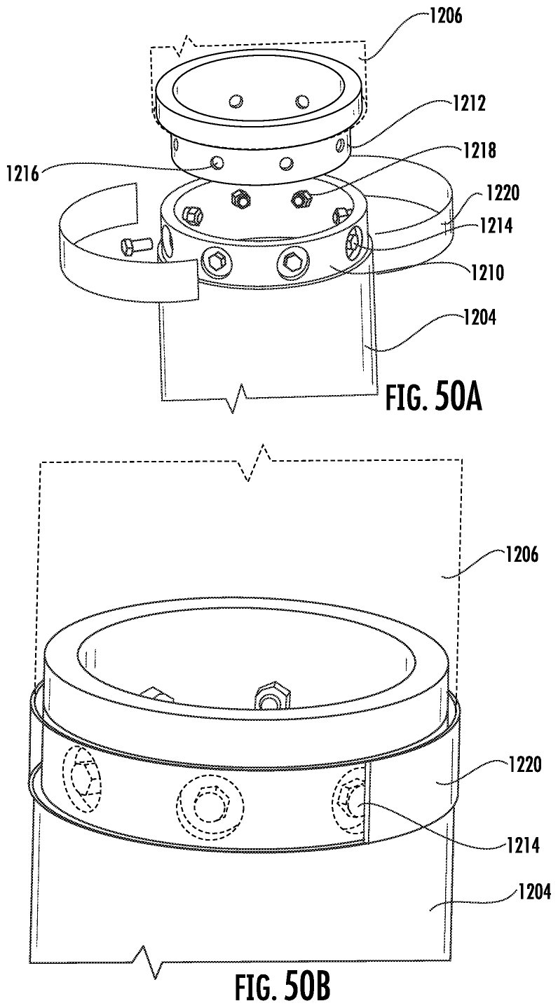

FIGS. 50A-B illustrate a joining arrangement in which the lower section 1204 includes a ring 1210 at its upper edge, and the upper section 1206 includes a slightly smaller ring 1212 with holes 1216 at its lower end. Threaded fasteners 1214 are inserted through the ring 1210 and into and nuts 1218 welded onto the inner surface of the ring 1210. The ring 1212 has holes 1216 that align with the fasteners 1214. The ring 1212 can be slipped inside the ring 1210, with the holes 1216 aligned with the nuts 1218 and secured by tightening the fasteners 1214. Covers 1220 can be employed to cover the gap between the sections 1204, 1206. This technique may be employed to customize pole height; for example, if sections are provided in 1, 3 and 5 foot lengths, any height pole (in one foot increments) can be constructed quickly and easily.

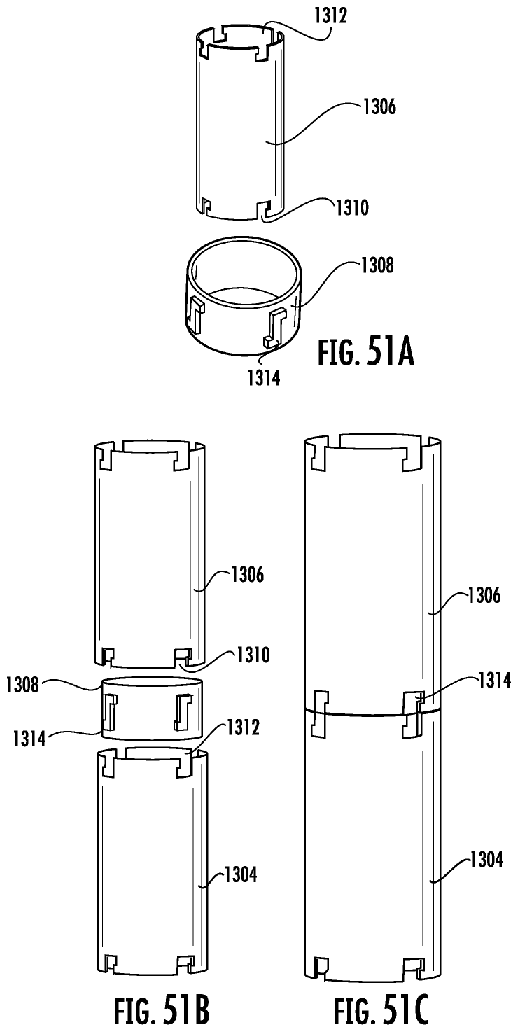

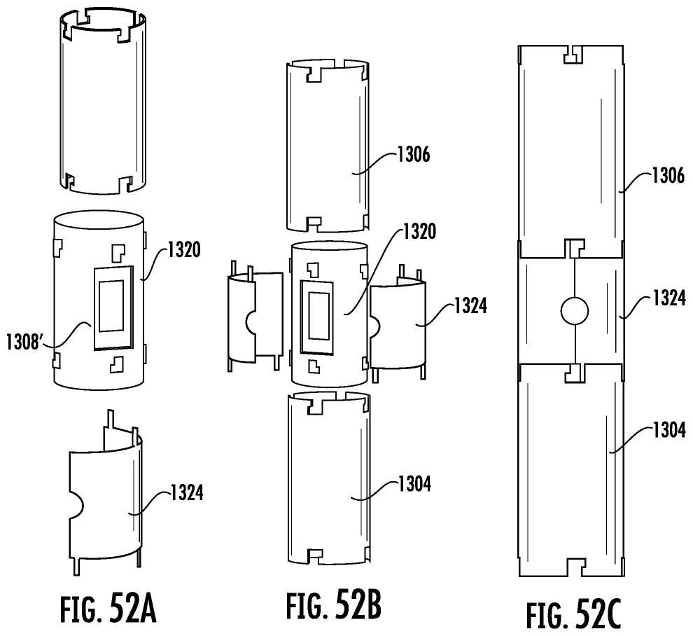

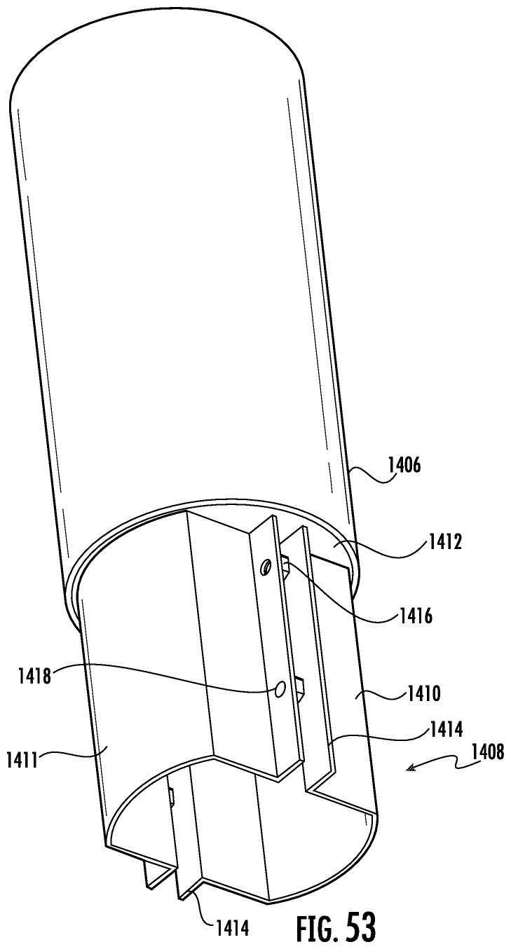

FIGS. 51A-C illustrate a joining arrangement in which a coupler 1308 is employed to join the sections 1304, 1306. The coupler 1308 is a short cylinder with four “block-S” shaped features 1314 on its outer surface. Each pole section 1304, 1306 has L-shaped, open-ended slots 1310, 1312 on its upper and lower edges, with the base leg of the “L” of the lower slots 1310 extending in the opposite rotative direction from the base leg of the “L” of the upper slots 1312. As shown in FIGS. 51B-C, the coupler 1308 is inserted inside the lower section 1304, with the features 1314 inserted into the slots 1312. The upper section 1306 is lowered onto the coupler 1308, with the slots 1310 receiving the features 1314. Rotation of upper section 1306 to the lower section 1304 causes the features 1314 to fully engage the slots 1310, 1312 and “lock” the sections 1304, 1306 in place. In the illustrated version, the upper edge of the lower section 1304 meets the lower edge of the uppers section 1306, such that no additional external cover is needed to cover a gap between the sections 1304, 1306. FIGS. 52A-C illustrate a variation of this arrangement, wherein the coupler 1308′ is taller and may be formed as a luminaire module or the like, with a mounting hole 1320 for the luminaire arm and a hand hole (not shown). In this embodiment covers 1324 may be included to cover the gap between the lower and upper sections 1304, 1306.

FIG. 53 illustrates a joining arrangement in which an expansion clamp 1408 is employed. Two clamp members 1410, 1411 are attached to a base 1412 that is mounted within the upper section 1406. Each clamp member 1410, 1411 has two flanges 1414. The clamp member 1410 has weld nuts 1416 attached to each flange 1414, whereas the clamp 1411 has holes 1418 in its flanges 1414. Bolts (not shown) are inserted through the holes 1418 and ito the weld nuts 1416. Rotation of the bolts forces the clamp members 1410, 1411 apart and against the inner surface of the lower section (not shown). In some embodiments mounted features may be included on the clamping members 1410, 1411 to improve stability of the joint.

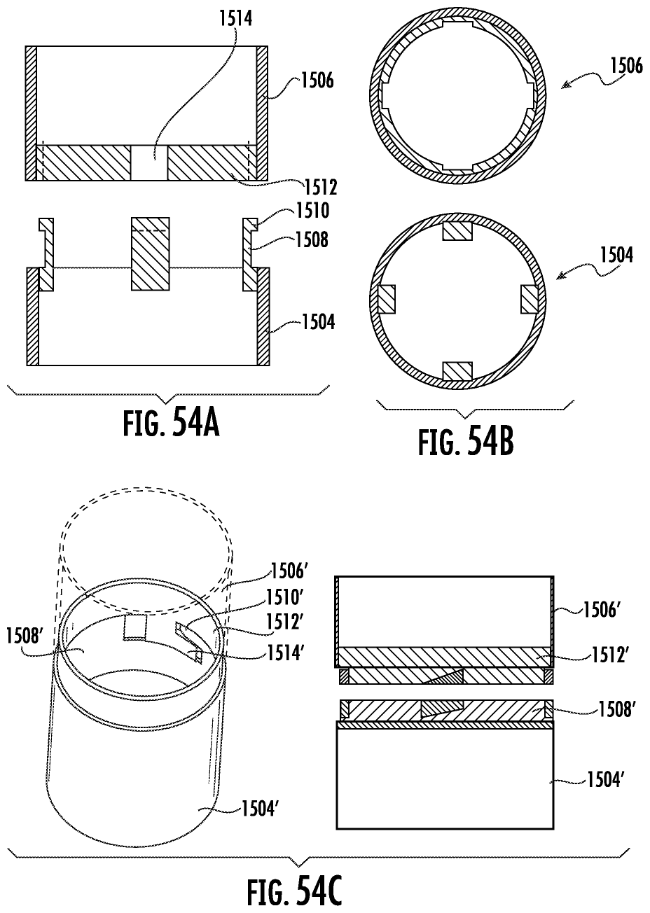

FIGS. 54A-B illustrate a joining arrangement in which the lower section 1504 has locking fingers 1508 with hooks 1510 extending upwardly from its upper edge, and the upper section 1506 includes a ring 1512 on its inner surface at its lower end. The ring 1512 includes slots 1514 that correspond to the fingers 1508. The upper section 1506 can be lowered onto the lower section 1504 with the slots 1514 aligned with the fingers 1508. When the upper section 1506 is fully lowered, it is rotated relative to the lower section 1504 sufficiently to allow the hooks 1510 to engage the upper edge of the ring 1512 to secure the lower and upper sections 1504, 1506 together. A variation of this joining arrangement is shown in FIG. 54C, in which both the upper and lower sections 1504′, 1506′ have respective rings 1508′, 1512′ with respective hooked fingers 1510′, 1514′. The hooks 1510′, 1514′ extend circumferentially (rather than radially as in FIGS. 54A and 54B). The hooks 1510′, 1514′ are also tapered, such that when the upper section 1506′ is rotated relative to the lower section 1504′, engagement of the hooks 1510′ with the hooks 1514′ acts as a wedge to lock the sections 1504′, 1506′ together.

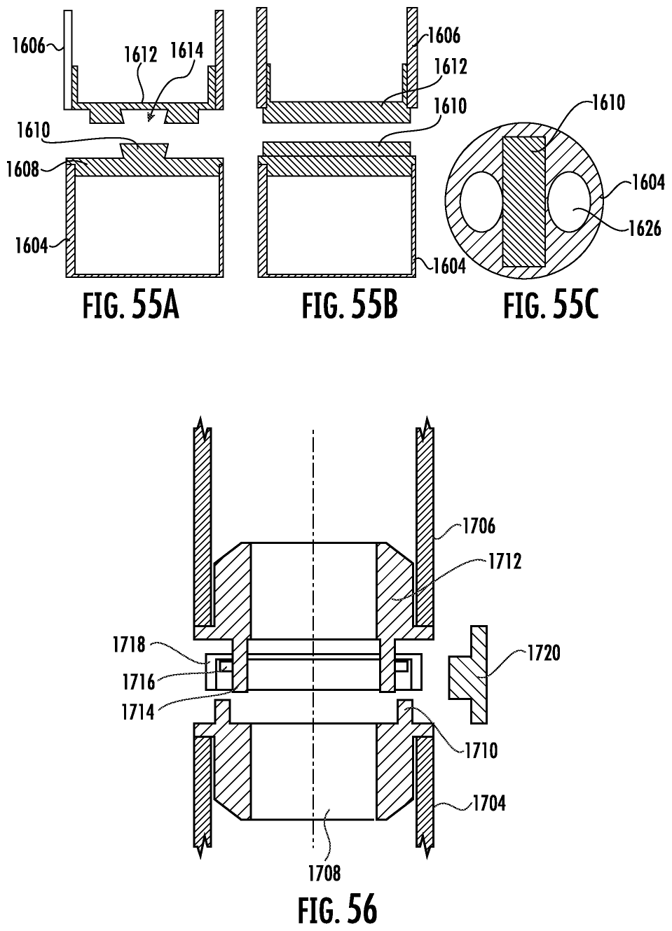

FIGS. 55A-C illustrate another joining arrangement, in which the lower section 1604 includes a cap 1608 with a “keystone”-shaped bar 1610 that extends diametrically across the cap 1608, and the upper section 1606 includes a cap 1612 with a channel 1614 configured to mate with the bar 1610. The upper section 1606 can be slid horizontally relative to the lower section 1604 to mate the bar 1610 within the channel 1614, thereby joining the upper and lower sections 1606, 1604. As shown in FIG. 55C, either or both of the caps 1608, 1612 may include holes 1626 to permit routing of cables and the like.

FIG. 56 illustrates a joining arrangement in which the lower section 1704 has a cap 1708 with a threaded ring 1710, and the upper section 1706 has a cap 1712 with a ring 1714 that is slightly smaller than the ring 1710. A circumferential lip 1716 extends outwardly from the ring 1714. A threaded collar 1718 is trapped between the lip 1716 and the lower edge of the upper section 1706. The lower and upper sections 1704, 1706 may be joined by lowering the upper section 1706 onto the lower section 1704 so that the ring 1714 slips inside the ring 1710. The collar 1718 can then be rotated relative to the ring 1710, with the threads of the collar 1718 mating with the threads of the ring 1710 to secure the lower and upper sections 1704, 1706 together. Covers 1720 may be added to cover any gap between the sections 1704, 1706.

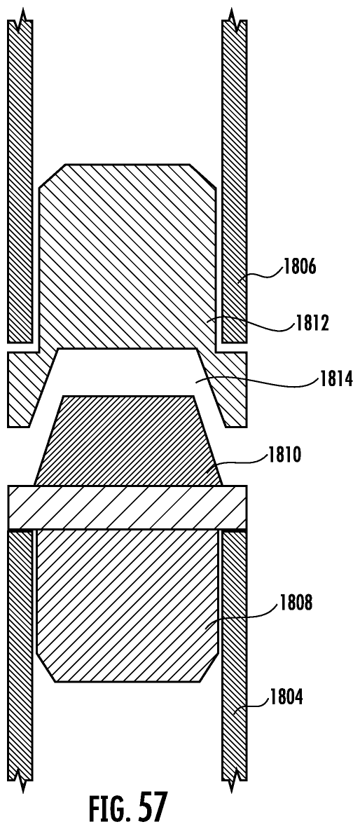

A variation of this arrangement is shown in FIG. 57. In this arrangement, the lower section 1804 has a cap 1808 with a threaded frustoconical projection 1810. The upper section 1806 has a cap 1812 with a threaded frustoconical recess 1814. The upper section 1806 is rotated relative to the lower section 1804 to engage the threads of the projection 1810 and recess 1814 to secure the sections 1804, 1806 together. Anti-rotation may be provided with set screws or the like.

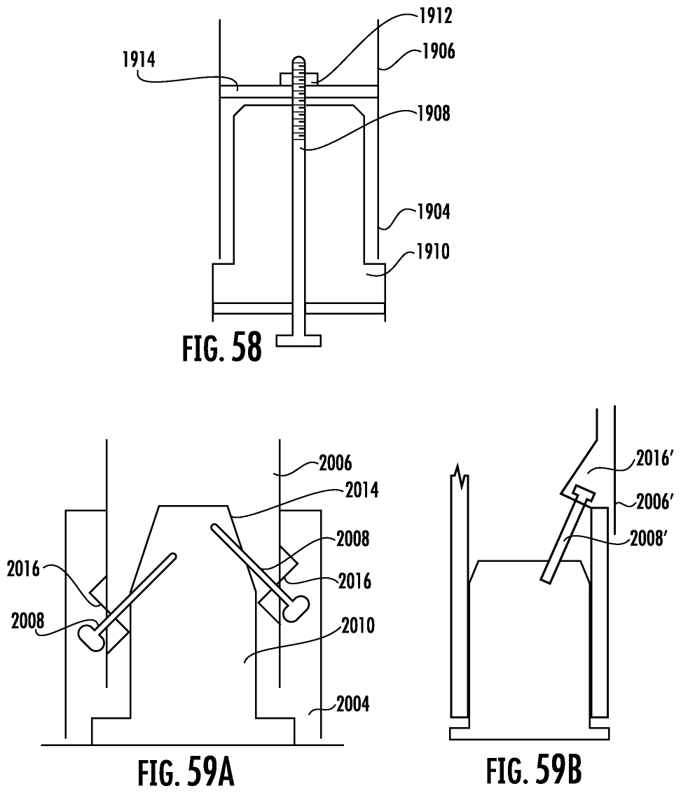

FIG. 58 illustrates an arrangement in which the lower section 1904 is secured to the upper section 1906 via a tension bolt 1908. The tension bolt 1908 extends through a cap 1910 mounted to the lower section and into a bolt 1912 mounted on a cap 1914 for the upper section 1906.

FIG. 59A illustrates an arrangement in which the lower section 2004 is further secured to the upper section 2006 with bolts 2008 inserted at an oblique angle to the longitudinal axis of the sections 2004, 2006. The arrangement may be one similar to that shown in FIG. 57 above, but with the frustoconical projection 2010 and the frustoconical recess 2014 lacking threads. The bolts 2008 are inserted though holes in angled panels 2016 in the lower section 2004, through the walls of the cap 2012, and into the projection 2010. Tightening of the bolts 2008 joins the sections 2004, 2006 together. This arrangement can draw the sections 2004, 2006 tightly together, but with bolts 2008 that can be accessed from outside of the sections 2004, 2006. An alternative arrangement is illustrated in FIG. 59B, wherein the bolts 2008′ are inserted into angled panels 2016′ that are located in the upper section 2006′.

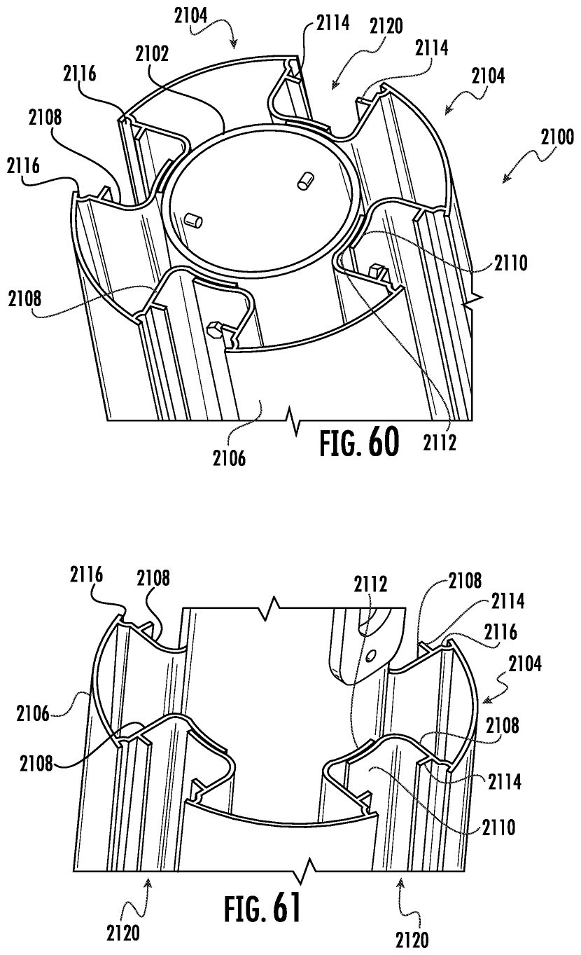

Additional variations of components discussed above may also be suitable for use in assemblies of the invention. Referring to FIGS. 60-64, a section 2100 includes a center pole 2102 and four quarter sections 2104. Each of the quarter sections 2104 includes an outer wall 2106, radially-inwardly-extending transition sections 2108 that extend form edge portions of the outer wall 2106, and inner walls 2110, 2112 that extend circumferentially from the inner edges of the transition sections 2108. As shown in FIGS. 60 and 61, a flange 2114 extends from each transition section 2108. Also, a small indentation 2116 is present in each transition section 2108 between the outer wall 2106 and the flange 2114.

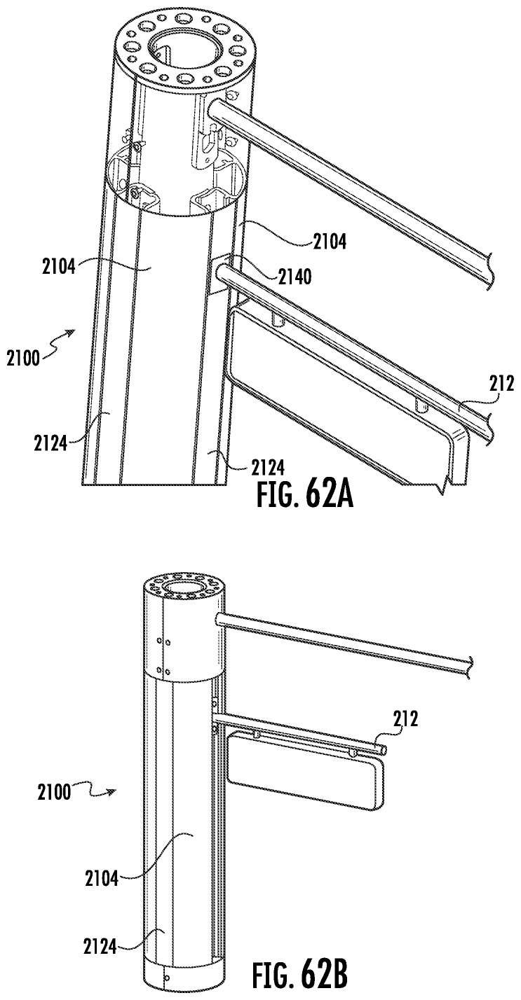

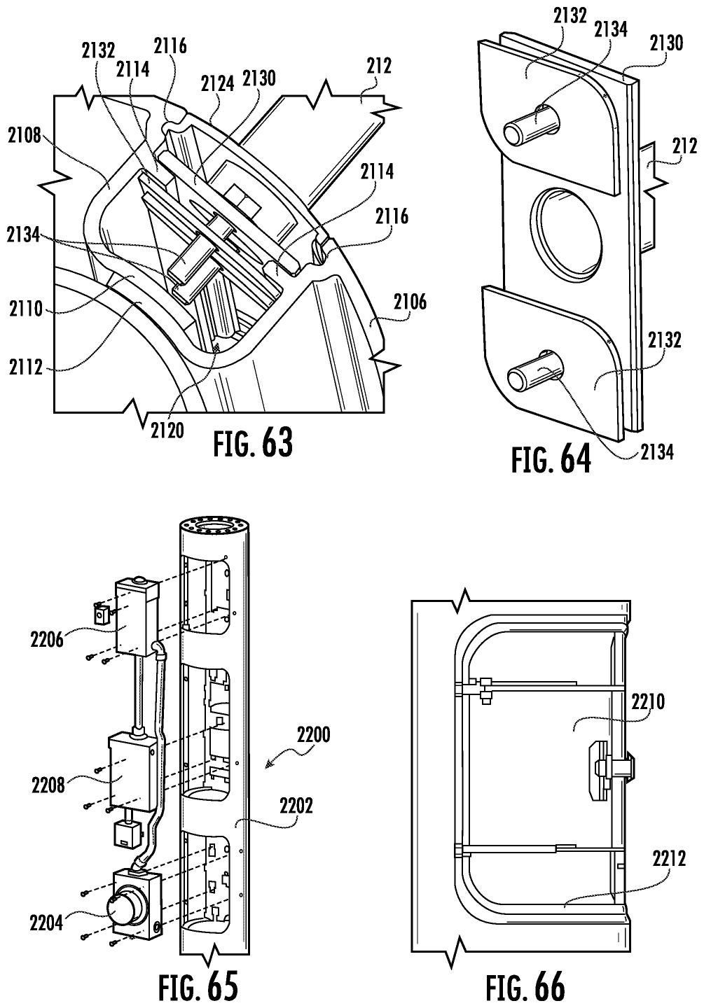

When the quarter sections 2104 are arranged around the pole 2102, the inner wall 2110 overlaps and is positioned radially outward from the inner wall 2112. The quarter sections 2104 are attached to the pole 2102 via bolts, screws or other fasteners. In this overlapping position, the transition sections 2108 form a gap 2120 between each adjacent pair of quarter sections 2104. The gap 2120 can house a power rail, such as those described above, and/or can provide a mounting location for accessories such as street signs 212 (see FIGS. 62A and 62B). In some embodiments, the gap 2120 is covered with a cover 2124 (similar to that shown at 712 above); the cover 2124 may be maintained in place within the indentations 2116 (see FIG. 63). Also, FIG. 69 shows a cap 2140 that may be inserted between lengths of the cover, wherein the arm for the street sign 212 may be inserted through a hole 2142 in the cap 2140.

Referring still to FIG. 63 and also to FIG. 64, an arrangement for hanging the street sign 212 is shown therein. The arm of the street sign 212 terminates in a mounting panel 2130. The mounting panel 2130 is positioned radially outwardly of the flanges 2114. Two nut plates 2132 are positioned radially inward of the flanges 2114. Bolts 2134 are inserted through holes in the mounting panel 2130 and in the nut plates 2132; the bolts 2134 may either be secured with threads in the nut plates 2132 or via a nut positioned radially inwardly of the nut plates 2132. Tightening of the bolts 2134 secures the mounting panel 2130 to the flanges 2114, which in turn mounts the street sign 212 or other accessory in the gap 2120.

Referring now to FIGS. 65 and 66, a base and power module, designated broadly at 2200, is shown therein. The base and power module 2200 includes a cylindrical housing 2202 that houses within a power meter 2204, a load center 2206 and an optional disconnect unit 2208. All are accessible through a door 2210 that is hinged to the housing 2202. The door 2210, which is typically formed of a portion of the housing 2202, is sized to cover most of the hole, and may include a gasket 2212 around its periphery to provide a seal when the door 2210 is closed. An exemplary hinge for the door 2210 is discussed in U.S. Patent Publication No. 2020/0378164 to Williams et al., the disclosure of which is hereby incorporated herein in full by reference; this hinge design can enable the door 2210 to close flush with the remainder of the housing 2202. In some embodiments, the opening for the door 2210 may be reinforced with a guide similar to guide 516 discussed above.

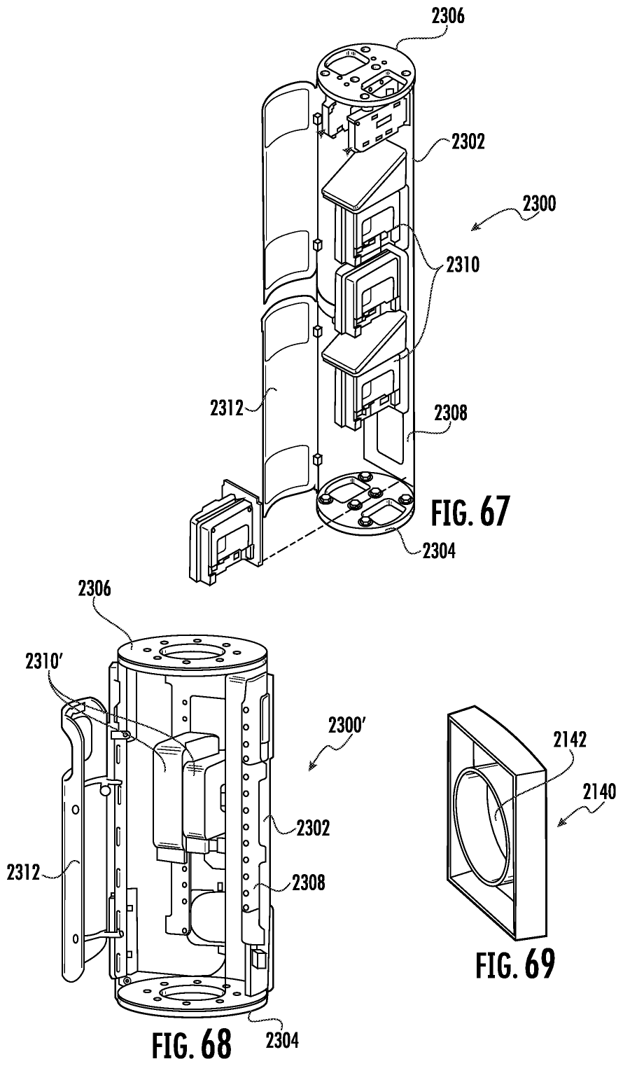

Referring now to FIGS. 67 and 68, two radio modules 2300, 2300′ are shown therein. Each of the radio modules 2300, 2300′ includes a housing 2302, upper and lower plates 2304, 2306, and a frame 2308 on which radios 2310, 2310′ are mounted in different arrangements. Each radio module 2300, 2300′ also includes one or more access doors 2312.

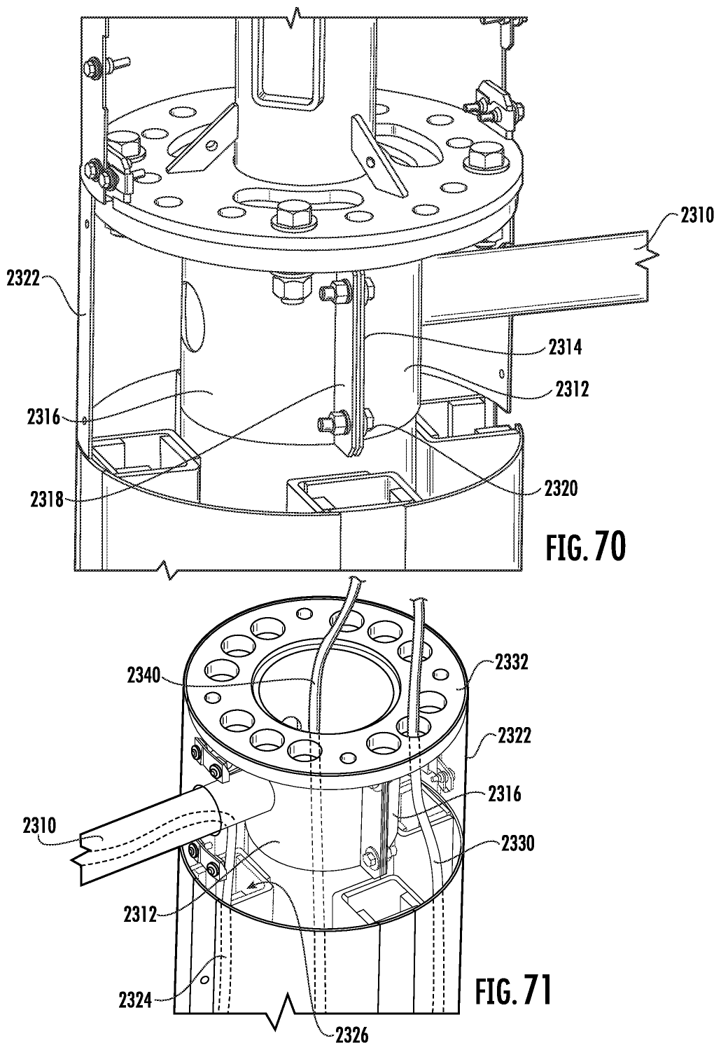

Referring now to FIGS. 70 and 71, a mounting arrangement for a luminaire arm 2310 is shown therein. The luminaire arm 2310 is connected (e.g., via welding) to a semicircular clamp 2312 with flanges 2314. A mating clamp 2316 with flanges 2318 is attached to the clamp 2312 via bolts 2320 inserted through holes in the flanges 2314, 2318. Covers 2322 surround the clamps 2312, 2316 to conceal them from view.

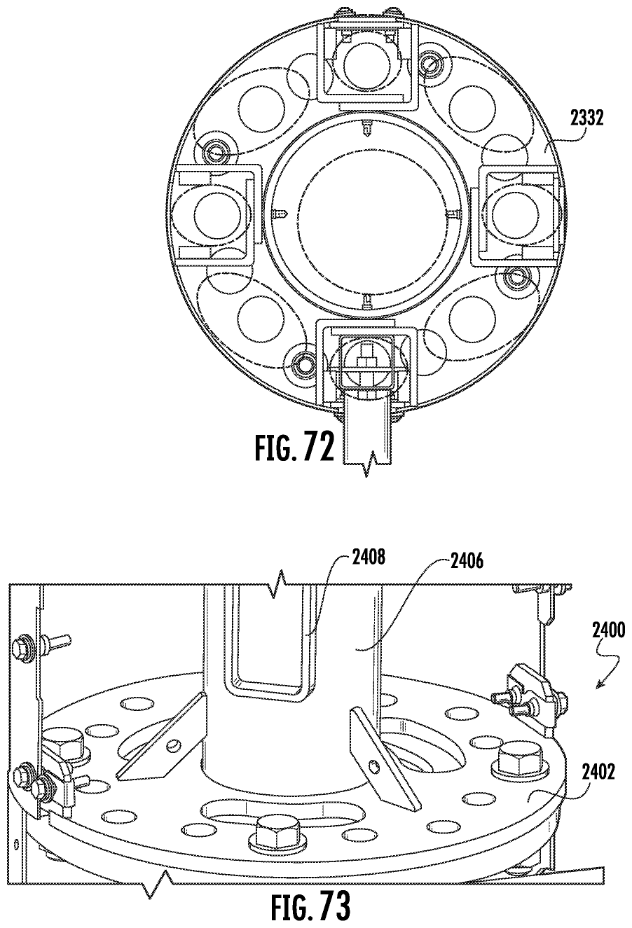

As shown in FIG. 71, cables may be routed through different openings created in the assembly. Cable 2324 is routed through a gap 2326 between quarter sections and into the luminaire arm 2310. Cable 2330 is routed within the cavity of a quarter section and through a opening in the upper plate 2332 of the arrangement. A third cable 2340 is routed through the lumen of the central pole. Other variations may also be employed, as various openings in the upper plate 2332 are shown in FIG. 72.

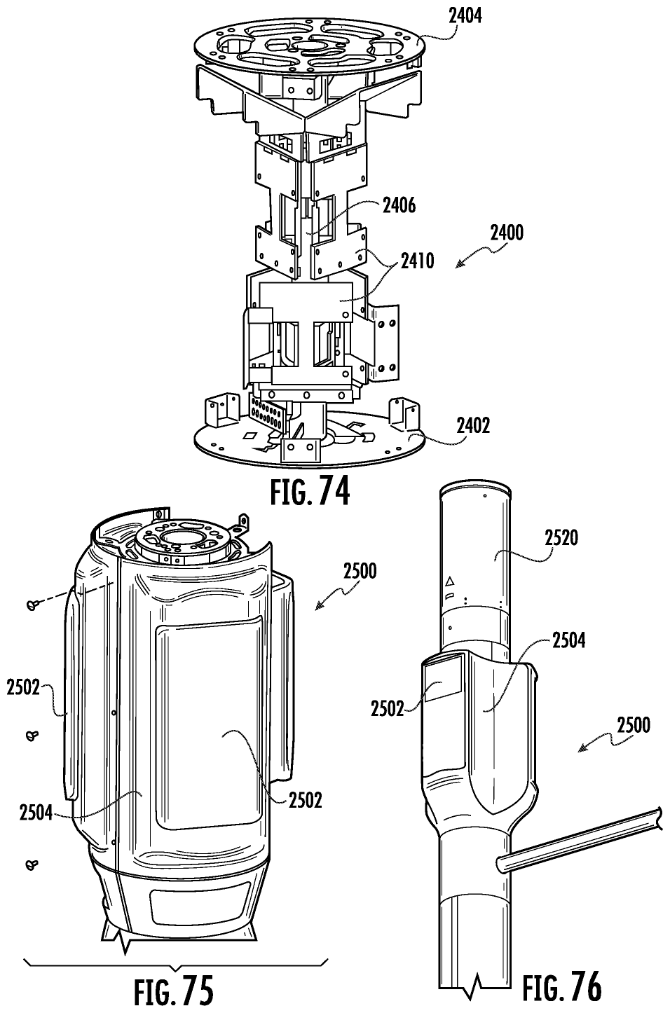

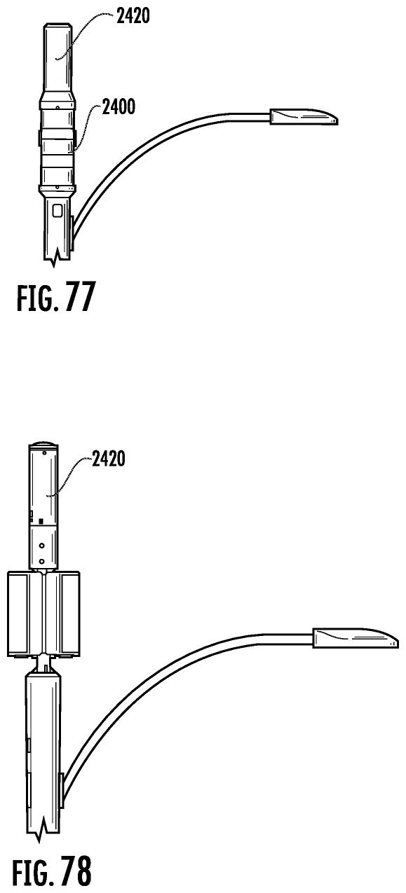

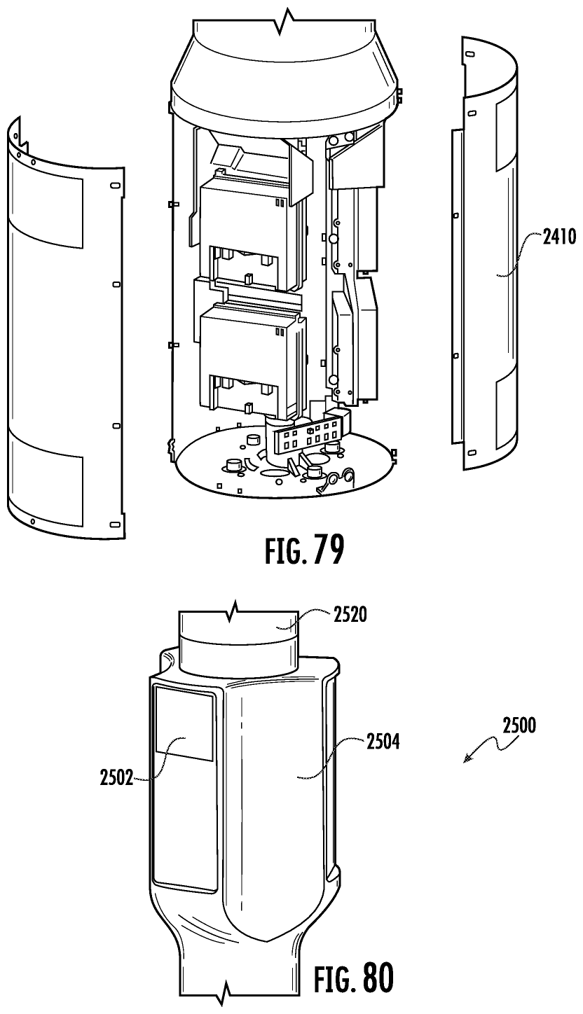

FIGS. 73 and 74 illustrate a radio module 2400 that may be suitable for housing “sub 6 GHz” radios (i.e., radios with 5G capability that operate below the 6 GHz frequency band). The module 2400 includes lower and upper plates 2402, 2404 that are mounted to a common hollow spine 2406. As seen in FIG. 73, the spine 2406 includes a reinforced opening 2408 that facilitates the routing of cables through the spine 2406. Mounting brackets 2410 of different configurations for different radios may be mounted to the spine 2406 (see FIG. 74). Exemplary mounting bracket configurations are illustrated in U.S. Provisional Patent Application No. 63/156,488 filed Mar. 4, 2021 and U.S. Provisional Patent Application No. 63/165,948 filed Mar. 25, 2021, the disclosures of which are hereby incorporated herein by reference in full. As shown in FIGS. 77 and 78, the radio module 2400 is typically mounted above a luminaire arm, and may optionally have a canister antenna 2420 (often a 4G antenna) mounted above it. FIG. 79 illustrates covers 2410 that may be employed to conceal the radios)

Another radio module 2500 is shown in FIGS. 75,76 and 80. The radio module 2500 includes three radios 2502 spaced 120 degrees apart and mounted to a central spine via brackets such as those discussed and cited above. Each radio 2502 may be part of an “active antenna”, wherein the radio and antenna are a combined single unit (this configuration is particularly popular for 5G radios). The module 2500 may include fascia 2504 to help conceal portions of the radios 2502 and improve the overall appearance. As shown in FIG. 76, a canister antenna 2520 may be mounted above the radio module 2500.

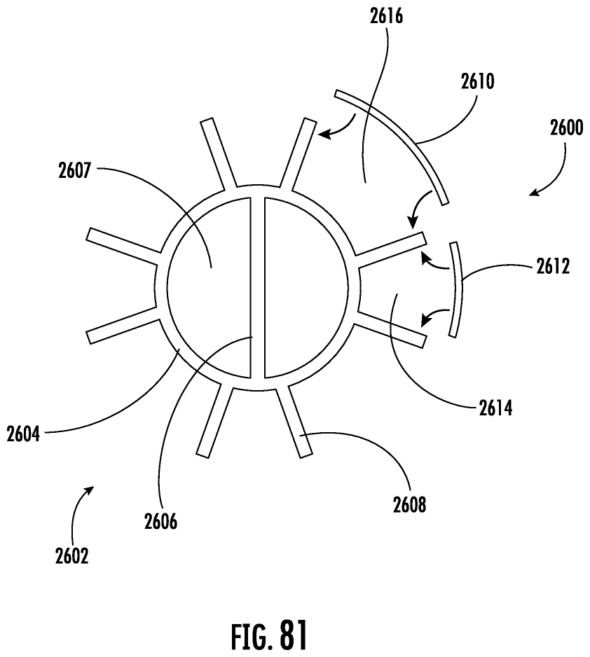

A further module for a metrocell assembly, designated broadly at 2600, is shown in FIG. 81. The module 2600 includes a central frame 2602 and a plurality of compartment covers 2610 and track covers 2612 (only one compartment cover 2610 and one track cover 2612 are shown in FIG. 81). The central frame 2602 is illustrated as a single unitary piece, which may be formed by extrusion, and which is typically formed of a metallic material such as aluminum or steel. The central frame 2602 includes a cylindrical base 2604 that is similar to the center poles discussed above (e.g., center pole 2012). The base 2604 may be divided onto separate cavities 2607 by one or more ribs 2606, wherein such cavities may provide pathways for the routing of cables. A plurality of spokes 2608 extend radially outwardly from the base 2604.

As shown in FIG. 81, the spokes 2608 are arranged in pairs that are equidistant from each other (in this instance, generally 90 degrees from each other). The spokes 2608 of a pair define a track or gap 2614 similar to the gaps 2012 described above. The track or gap 2614 may house a power rail for the attachment of electrically-powered devices, or may include other features that enable the attachment of other components (such as the street signs 212 described above). The spokes 2608 may also include features (such as grooves, flanges or the like) that facilitate the attachment of a track cover 2612).

Adjacent spokes 2608 of adjacent pairs define compartments 2616. The compartments 2616 may be empty, or may provide pathways for cables. The spokes 2608 may include features (such as grooves, flanges or the like) that facilitate the mounting of the compartment covers 2610. As one example, the compartment covers 2610 may be sufficiently flexible to be bent slightly, such that their edges may fit within grooves in the spokes 2608.

In some embodiments, the spokes 2608 may include features configured to enable components to be attached according to the “80/20” convention established by 80/20, Inc. (Columbia City, Ind.). Exemplary configurations of the “80/20” system are shown in U.S. Pat. Nos. 5,429,438 and 6,481,177, each of which is hereby incorporated herein b y reference in full. Thus, such features may be introduced into the spokes 2608 to permit the easy attachment of components having a complementary feature. It should be noted that such “80/20” features may also be introduced into other radially-extending components discussed above, such as the track walls 724, 726 of the modules 720, 720, 740, 750 above.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A module for a metrocell assembly, comprising:
a hollow, elongate cylindrical housing; and
at least one power rail attached to and extending longitudinally relative to the housing and accessible from the exterior of the housing;
wherein the at least one power rail is configured to receive an accessory mounted on the power rail and to provide electrical contact from within the housing to the accessory.

2. The module defined in claim 1, wherein the at least one power rail comprises two power rails.

3. The module defined in claim 1, wherein the housing has a length, and the at least one power rail extends longitudinally over a majority of the length of the housing.

4. The module defined in claim 1, wherein the at least one power rail is configured to mount and provide electrical contact to two accessories.

5. The module defined in claim 1, further comprising the accessory mounted on the power rail, wherein the accessory is selected from the group consisting of: a street sign, a camera, a pedestrian light, a crosswalk light, a traffic sign, and a luminaire.

6. The module defined in claim 1, in combination with a cellular antenna module mounted above the module.

7. The combination defined in claim 6, further comprising a base on which the module is mounted, and wherein a cellular radio is mounted in one of the base, the housing of the module, or the antenna module.

8-20. (canceled)

21. A module for a metrocell, comprising:
a plurality of outer sections, each of the outer sections extending longitudinally, the outer sections arranged to form generally a cylinder;
wherein the outer sections include features that form at least one channel configured for the mounting of an accessory therein.

22. The module defined in claim 21, further comprising a central pole, and wherein the outer sections are mounted to the central pole.

23. The module defined in claim 22, wherein a portion of the central pole extends longitudinally beyond the outer sections, and wherein a luminaire arm is clamped to the portion of the pole.

24. The module defined in claim 21, wherein the outer sections are quarter-sections.

25. The module defined in claim 21, wherein each of the outer sections includes an outer wall, an inner wall, and a radially-extending transition section between the outer and inner walls, wherein the gaps are defined by the transition sections and the inner walls of adjacent outer sections.

26. The module defined in claim 25, wherein the inner walls of adjacent outer sections overlap.

27. The module defined in claim 25, wherein each transition section includes a feature for mounting of an accessory.

28. The module defined in claim 25, in combination with an accessory mounted in one of the at least one channels.

29. A module for a metrocell, comprising:
a central frame comprising a cylindrical base and a plurality of spokes extending radially outwardly from the cylindrical base;
a plurality of compartment covers extending between adjacent spokes to form a plurality of compartments; and
a plurality of track covers extending between adjacent spokes to forma plurality of tracks.

30. The module defined in claim 29, wherein the compartments and tracks are arranged in alternating fashion around the base.

31. The module defined in claim 29, wherein each of the spokes includes first features configured to facilitate mounting of the compartment covers and second features configured to facilitate mounting of the track covers.

32. The module defined in claim 29, in combination with an accessory mounted in one of the tracks.

33. The module defined in claim 29, wherein the base includes a diametric rib.

34. The module defined in claim 29, wherein the frame is a unitary member.

35-50. (canceled)
